(19) United States
(12) Patent Application Publication
(10) Pub. No.: US 2014/0255674 A1
(43) Pub. Date: Sep. 11, 2014

(54) MULTI-LAYERED SHRINK FILMS

(71) Applicant: Dow Global Technologies LLC, Midland, MI (US)

(72) Inventors: Colleen M. Tice, Houston, TX (US); Teresa P. Karjala, Lake Jackson, TX (US); Lei Hao, Shanghai (CN); Xiao B. Yun, Beijing (CN); Chang Wu, Shanghai (CN)

(21) Appl. No.: 14/350,091

(22) PCT Filed: Oct. 21, 2011
(86) PCT No.: PCT/CN2011/081107

§ 371 Date: Apr. 7, 2014

(51) Int. Cl. B32B 27/30

(52) U.S. Cl. CPC B32B 27/306; B32B 2250/40; B32B 2307/736
USPC 428/213; 428/500; 428/518; 428/516; 428/218

(57) ABSTRACT

A multi-layered shrink film comprising: at least three layers including two skin layers and at least one core layer; wherein at least one layer comprises from 10 to 100 weight percent units derived from one or more ethylene-based polymer compositions characterized by having Comonomer Distribution Constant in the range of from 75 to 220, a vinyl unsaturation of from 30 to 100 vinyls per one million carbon atoms present in the backbone of the ethylene-based polymer composition; a zero shear viscosity ratio (ZSVR) in the range from at least 2.5 to 15; a density in the range of 0.924 to 0.940 g/cm³, a melt index (I₂) in the range of from 0.1 to 1 g/10 minutes, a molecular weight distribution (Mw/Mn) in the range of from 2.5 to 10, and a molecular weight distribution (Mz/Mw) in the range of from 1.5 to 4; and wherein the multi-layered film exhibits at least one characteristic selected from the group consisting of 45 degree gloss of at least 50%, a total haze of 15% or less, an internal haze of 8% or less, 1% CD Secant Modulus of 43,000 psi or greater, 1% MD Secant Modulus of 38,000 psi or greater, CD shrink tension of at least 0.7 psi, and/or MD shrink tension of at least 10 psi.

### FIELD OF INVENTION

The instant invention relates to a multi-layered shrink film.

### BACKGROUND OF THE INVENTION

Downgauging is a trend for shrink film so as to reduce cost and material consumption. In order to reduce shrink film thickness, however, the film material must maintain high stiffness to ensure packaging speed and hand feel. Further, it is desired for shrink films to have excellent optics and clarity for consumer impression and market differentiation. Currently, film stiffness is improved by including a high density polyethylene (HDPE) component in LDPE based film at the expense of film clarity. Films made from conventional low density polyethylene (LDPE) using high pressure free radical chemistry are also typically used for their high shrink characteristics. LDPE films, however, have low modulus, thereby limiting the ability to downgauge.

### SUMMARY OF THE INVENTION

The instant invention is a shrink film. In one embodiment, the instant invention provides a multi-layered shrink film comprising: at least three layers including two skin layers and at least one core layer; wherein at least one layer comprises from 10 to 100 weight percent units derived from one or more ethylene-based polymer compositions characterized by having Comonomer Distribution Constant (CDC) in the range of from 75 to 220, a vinyl unsaturation of from 30 to 100 vinyls per one million carbon atoms present in the backbone of the ethylene-based polymer composition; a zero shear viscosity ratio (ZSVR) in the range from at least 2.5 to 15; a density in the range of 0.924 to 0.940 g/cm³, a melt index (1₂) in the range of from 0.1 to 1 g/10 minutes, a molecular weight distribution (Mw/Mn) in the range of from 2.5 to 10, and a molecular weight distribution (Mz/Mw) in the range of from 1.5 to 4; and wherein the multi-layered film exhibits at least one characteristic selected from the group consisting of 45 degree gloss of at least 50%, a total haze of 15% or less, an internal haze of 8% or less, 1% CD Secant Modulus of 43,000 psi or greater, 1% MD Secant Modulus of 38,000 psi or greater, CD shrink tension of at least 0.7 psi, and/or MD shrink tension of at least 10 psi.

### BRIEF DESCRIPTION OF THE DRAWINGS

For the purpose of illustrating the invention, there is shown in the drawings a form that is exemplary; it being understood, however, that this invention is not limited to the precise arrangements and instrumentalities shown.

FIG. 1 is dynamical mechanical spectroscopy complex viscosity data versus frequency for Inventive Composition Examples 1-4;

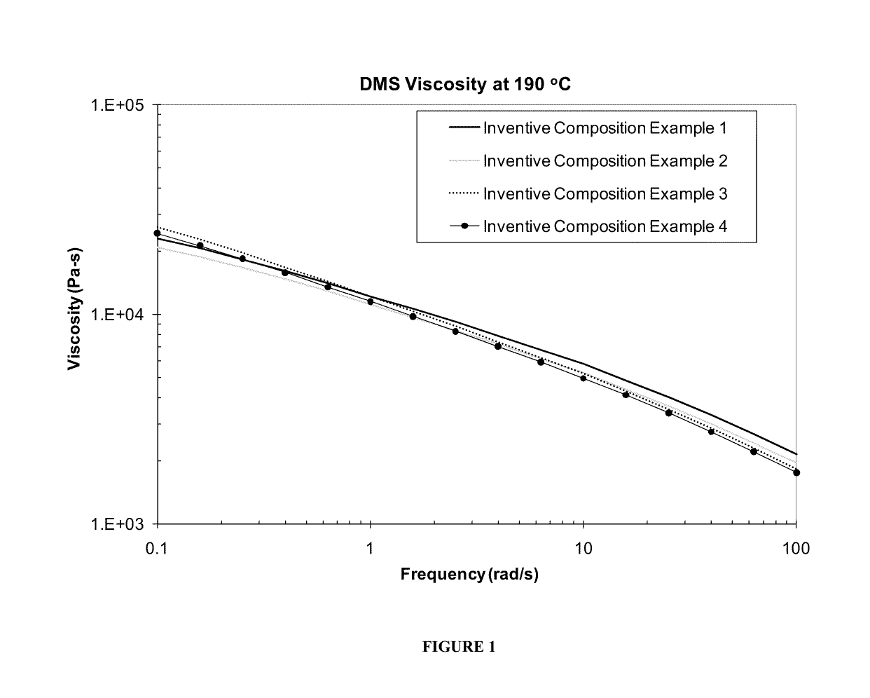

FIG. 2 is dynamical mechanical spectroscopy tan delta data versus frequency for Inventive Composition Examples 1-4;

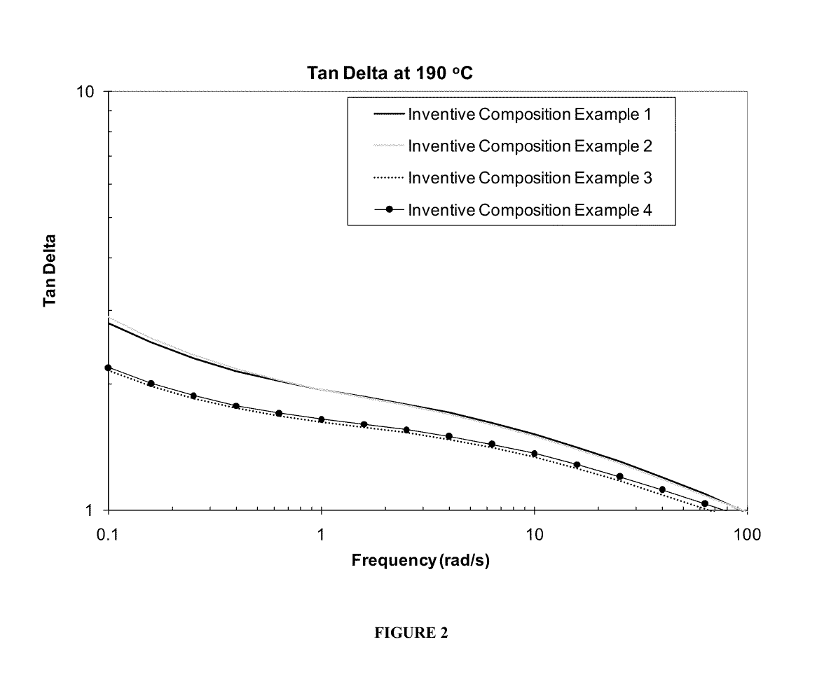

FIG. 3 is a dynamical mechanical spectroscopy graph of phase angle vs. complex modulus (Van-Gurp Palmen plot) for Inventive Composition Examples 1-4;

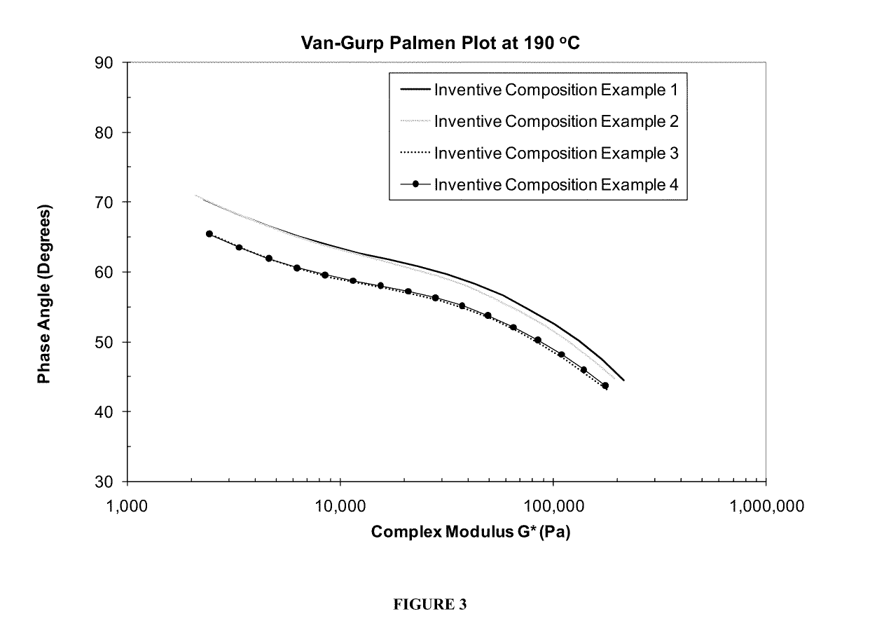

FIG. 4 is melt strength data at 190 ° C. for Inventive Composition Examples 1-4;

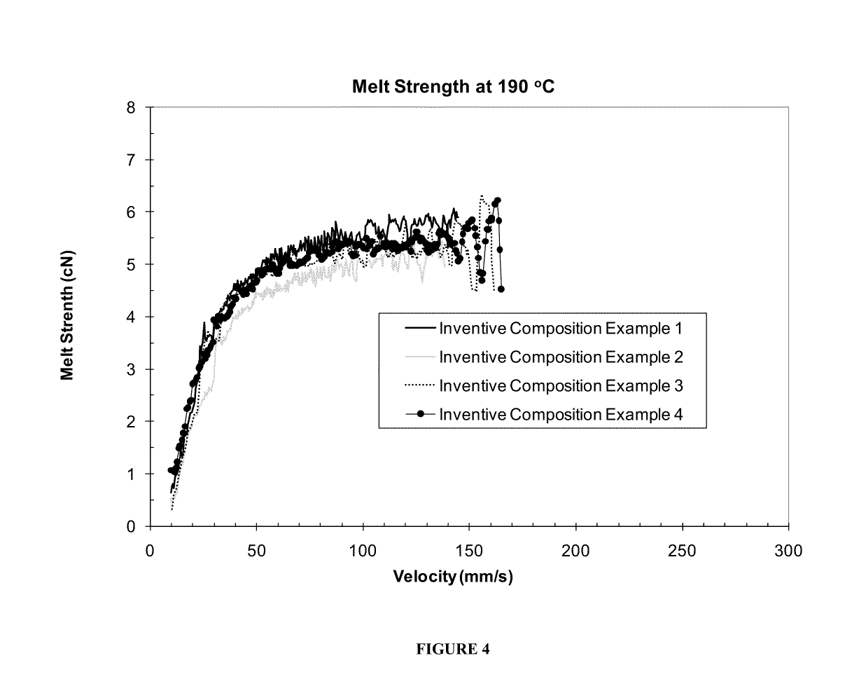

FIG. 5 is conventional GPC plot for Inventive Composition Examples 1-4; and

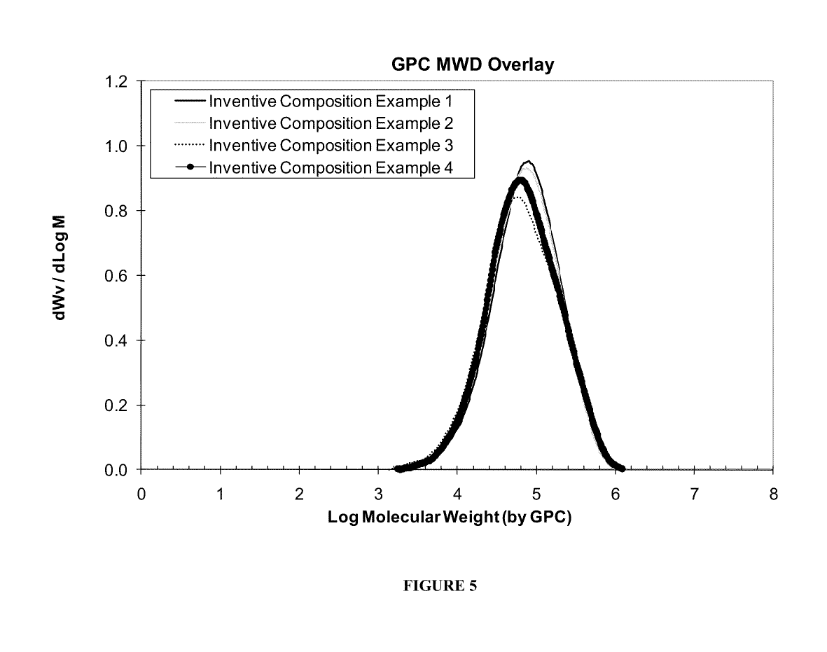

FIG. 6 is CEF plot for Inventive Composition Examples 1-4.

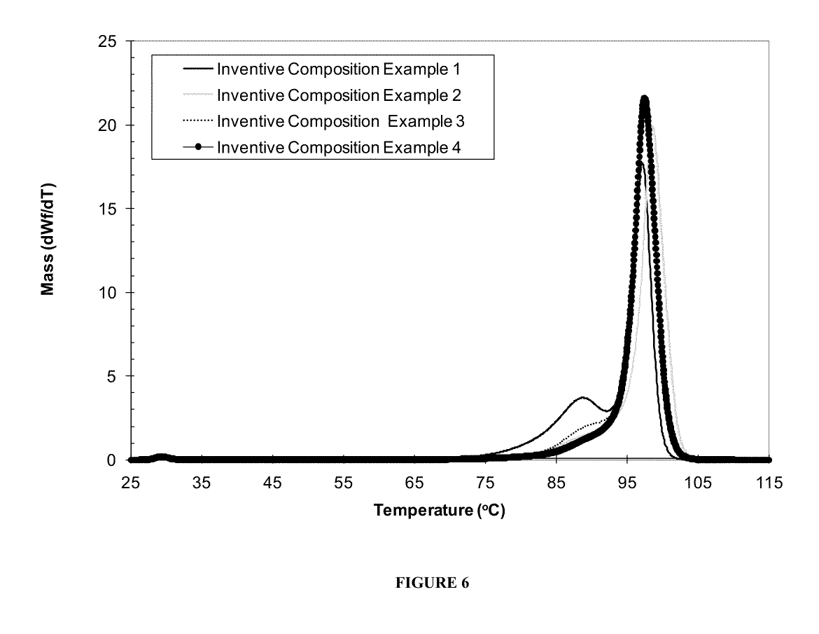

### DETAILED DESCRIPTION OF THE INVENTION

The instant invention is a multi-layered shrink film. The multi-layered shrink film according to the present invention comprises: at least three layers including two skin layers and at least one core layer; wherein at least one layer comprises from 10 to 100 weight percent units derived from an ethylene-based polymer composition comprising: (a) less than or equal to 100 percent by weight of the units derived from ethylene; and (b) less than 30 percent by weight of units derived from one or more a-olefin comonomers; wherein the ethylene-based polymer composition characterized by having a CDC in the range of from 75 to 220, a vinyl unsaturation of from 30 to 100 vinyls per one million carbon atoms present in the backbone of the ethylene-based polymer composition; a ZSVR in the range from at least 2.5 to 15; a density in the range of 0.924 to 0.940 g/cm³, a melt index (I₂) in the range of from 0.1 to 1 g/10 minutes, a molecular weight distribution (Mw/Mn) in the range of from 2.5 to 10, and a molecular weight distribution (Mz/Mw) in the range of from 1.5 to 4; and wherein the multi-layered film exhibits at least one characteristic selected from the group consisting of 45 degree gloss of at least 50%, a total haze of 15% or less, an internal haze of 8% or less, 1% CD Secant Modulus of 43,000 psi or greater, 1% MD Secant Modulus of 38,000 psi or greater, CD shrink tension of at least 0.7 psi, and/or MD shrink tension of at least 10 psi.

The multi-layered shrink film according to the present invention comprises: at least three layers including two skin layers and at least one core layer; wherein at least one layer comprises from 10 to 100 weight percent units derived from an ethylene-based polymer composition. All individual values and subranges from 10 to 100 weight percent are included herein and disclosed herein. For example, at least one layer may comprise units derived from an ethylene-based polymer composition from a lower limit of 10, 20, 30, 40, 50, 60, 70, 80 or 90 weight percent to an upper limit of 20, 30, 40, 50, 60, 70, 80, 90, or 100 weight percent. For example, the amount of units derived from an ethylene-based polymer composition in at least one layer may be in the range from 10 to 100 weight percent, or from 20 to 65 weight percent, or from 30 to 70 weight percent.

The ethylene-based polymer composition comprises (a) less than or equal to 100 percent, for example, at least 70 percent, or at least 80 percent, or at least 90 percent, by weight of the units derived from ethylene; and (b) less than 30 percent, for example, less than 25 percent, or less than 20 percent, or less than 10 percent, by weight of units derived from one or more a-olefin comonomers. The term “ethylene-based polymer composition” refers to a polymer that contains more than 50 mole percent polymerized ethylene monomer (based on the total amount of polymerizable monomers) and, optionally, may contain at least one comonomer. The α-olefin comonomers typically have no more than 20 carbon atoms. For example, the α-olefin comonomers may preferably have 3 to 10 carbon atoms, and more preferably 3 to 8 carbon atoms. Exemplary α-olefin comonomers include, but are not limited to, propylene, 1-butene, 1-pentene, 1-hexene, 1-heptene, 1-octene, 1-nonene, 1-decene, and 4-methyl-1-pentene. The one or more a-olefin comonomers may, for example, be selected from the group consisting of propylene, 1-butene, 1-hexene, and 1-octene; or in the alternative, from the group consisting of 1-hexene and 1-octene.

In another embodiment, the ethylene-based polymer composition comprises less than or equal to 100 parts, for example, less than 10 parts, less than 8 parts, less than 5 parts, less than 4 parts, less than 1 parts, less than 0.5 parts, or less than 0.1 parts, by weight of metal complex residues remaining from a catalyst system comprising a metal complex of a polyvalent aryloxyether per one million parts of the ethylene-based polymer composition. The metal complex residues remaining from the catalyst system comprising a metal complex of a polyvalent aryloxyether in the ethylene-based polymer composition may be measured by x-ray fluorescence (XRF), which is calibrated to reference standards. The polymer composition granules can be compression molded at elevated temperature into plaques having a thickness of about ⅜ of an inch for the x-ray measurement in a preferred method. At very low concentrations of metal complex, such as below 0.1 ppm, ICP-AES (inductively coupled plasma-atomic emission spectroscopy) would be a suitable method to determine metal complex residues present in the ethylene-based polymer composition.

The ethylene-based polymer composition may further comprise additional components such as one or more other polymers and/or one or more additives. Such additives include, but are not limited to, antistatic agents, color enhancers, dyes, lubricants, fillers, pigments, primary antioxidants, secondary antioxidants, processing aids, UV stabilizers, anti-blocks, slip agents, tackifiers, fire retardants, anti-microbial agents, odor reducer agents, anti-fungal agents, and combinations thereof The ethylene-based polymer composition may contain from about 0.1 to about 10 percent by the combined weight of such additives, based on the weight of the ethylene-based polymer composition including such additives.

In one embodiment, ethylene-based polymer composition has a comonomer distribution profile comprising a monomodal distribution or a bimodal distribution in the temperature range of from 35° C. to 120° C., excluding purge.

Any conventional ethylene (co)polymerization reaction processes may be employed to produce the ethylene-based polymer composition. Such conventional ethylene (co)polymerization reaction processes include, but are not limited to, slurry phase polymerization process, solution phase polymerization process, and combinations thereof using one or more conventional reactors, e.g., loop reactors, stirred tank reactors, batch reactors in parallel, series, and/or any combinations thereof

In one embodiment, the ethylene-based polymer is prepared via a process comprising the steps of: (a) polymerizing ethylene and optionally one or more a-olefins in the presence of a first catalyst system to form a semi-crystalline ethylene-based polymer in a first reactor or a first part of a multi-part reactor; and (b) reacting freshly supplied ethylene and optionally one or more a-olefins in the presence of a second catalyst system comprising an organometallic catalyst thereby forming an ethylene-based polymer composition in at least one other reactor or a later part of a multi-part reactor, wherein at least one of the catalyst systems in step (a) or (b) comprises a metal complex of a polyvalent aryloxyether corresponding to the formula:

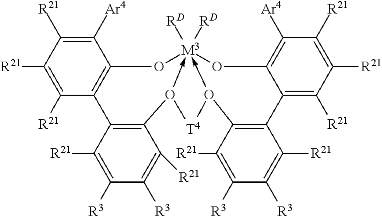

wherein M³ is Ti, Hf or Zr, preferably Zr; Ar⁴ is independently in each occurrence a substituted C₉₋₂₀ aryl group, wherein the substituents, independently in each occurrence, are selected from the group consisting of alkyl; cycloalkyl; and aryl groups; and halo-, trihydrocarbylsilyl-and halohydrocarbyl-substituted derivatives thereof, with the proviso that at least one substituent lacks co-planarity with the aryl group to which it is attached; T⁴ is independently in each occurrence a C₂₋₂₀ alkylene, cycloalkylene or cycloalkenylene group, or an inertly substituted derivative thereof; R²¹ is independently in each occurrence hydrogen, halo, hydrocarbyl, trihydrocarbylsilyl, trihydrocarbylsilylhydrocarbyl, alkoxy or di-(hydro-carbyl)amino group of up to 50 atoms not counting hydrogen; R³ is independently in each occurrence hydrogen, halo, hydrocarbyl, trihydrocarbylsilyl, trihydrocarbylsilylhydro-carbyl, alkoxy or amino of up to 50 atoms not counting hydrogen, or two R³ groups on the same arylene ring together or an R³ and an R²¹ group on the same or different arylene ring together form a divalent ligand group attached to the arylene group in two positions or join two different arylene rings together; and R^{D} is independently in each occurrence halo or a hydro-carbyl or trihydrocarbylsilyl group of up to 20 atoms not counting hydrogen, or 2 R^{D} groups together are a hydrocarbylene, hydrocarbadiyl, diene, or poly(hydrocarbyl)silylene group.

The ethylene-based polymer composition may be produced via a solution polymerization according to the following exemplary process. All raw materials (ethylene, 1-octene) and the process solvent (a narrow boiling range high-purity isoparaffinic solvent commercially available under the tradename Isopar E from ExxonMobil Corporation) are purified with molecular sieves before introduction into the reaction environment. Hydrogen is supplied in pressurized cylinders as a high purity grade and is not further purified. The reactor monomer feed (ethylene) stream is pressurized via mechanical compressor to a pressure that is above the reaction pressure, approximately to 750 psig. The solvent and comonomer (1-octene) feed is pressurized via mechanical positive displacement pump to a pressure that is above the reaction pressure, approximately 750 psig. The individual catalyst components can be manually batch diluted to specified component concentrations with purified solvent (Isopar E) and pressurized to a pressure that is above the reaction pressure, approximately 750 psig. All reaction feed flows can be measured with mass flow meters, independently controlled with computer automated valve control systems. The continuous solution polymerization reactor system according to the present invention can consist of two liquid full, non-adiabatic, isothermal, circulating, and independently controlled loops operating in a series configuration. Each reactor has independent control of all fresh solvent, monomer, comonomer, hydrogen, and catalyst component feeds. The combined solvent, monomer, comonomer and hydrogen feed to each reactor is independently temperature controlled to anywhere between 5° C. to 50° C. and typically 40° C. by passing the feed stream through a heat exchanger. The fresh comonomer feed to the polymerization reactors can be manually aligned to add comonomer to one of three choices: the first reactor, the second reactor, or the common solvent and then split between both reactors proportionate to the solvent feed split. The total fresh feed to each polymerization reactor is injected into the reactor at two locations per reactor roughly with equal reactor volumes between each injection location. The fresh feed is controlled typically with each injector receiving half of the total fresh feed mass flow. The catalyst components are injected into the polymerization reactor through specially designed injection stingers and are each separately injected into the same relative location in the reactor with no contact time prior to the reactor. The primary catalyst component feed is computer controlled to maintain the reactor monomer concentration at a specified target. The two cocatalyst components are fed based on calculated specified molar ratios to the primary catalyst component. Immediately following each fresh injection location (either feed or catalyst), the feed streams are mixed with the circulating polymerization reactor contents with static mixing elements. The contents of each reactor are continuously circulated through heat exchangers responsible for removing much of the heat of reaction and with the temperature of the coolant side responsible for maintaining isothermal reaction environment at the specified temperature. Circulation around each reactor loop is provided by a screw pump. The effluent from the first polymerization reactor (containing solvent, monomer, comonomer, hydrogen, catalyst components, and molten polymer) exits the first reactor loop and passes through a control valve (responsible for maintaining the pressure of the first reactor at a specified target) and is injected into the second polymerization reactor of similar design. As the stream exits the reactor, it is contacted with a deactivating agent, e.g. water, to stop the reaction. In addition, various additives such as anti-oxidants, can be added at this point. The stream then goes through another set of static mixing elements to evenly disperse the catalyst deactivating agent and additives. Following additive addition, the effluent (containing solvent, monomer, comonomer, hydrogen, catalyst components, and molten polymer) passes through a heat exchanger to raise the stream temperature in preparation for separation of the polymer from the other lower boiling reaction components. The stream then enters a two stage separation and devolatilization system where the polymer is removed from the solvent, hydrogen, and unreacted monomer and comonomer. The recycled stream is purified before entering the reactor again. The separated and devolatized polymer melt is pumped through a die specially designed for underwater pelletization, cut into uniform solid pellets, dried, and transferred into a hopper.

The ethylene-based polymer composition useful in embodiments of the invention is characterized by a CDC in the range of from 75 to 220. All individual values and subranges from 75 to 220 are included herein and disclosed herein; for example, the ethylene-based polymer composition CDC can be from a lower limit of 75, 95, 115, 135, 155, 175, or 195 to an upper limit of 80, 100, 120, 140, 160, 180, or 220. For example, the ethylene-based polymer composition Comonomer Distribution Constant may be in the range of from 75 to 200, or from 100 to 180, or from 110 to 160, or from 120 to 155.

The ethylene-based polymer composition useful in embodiments of the invention is further characterized by a vinyl unsaturation of from 30 to 100 vinyls per one million carbon atoms present in the backbone of the ethylene-based polymer composition (vinyls/1,000,000 C). All individual values and subranges from 30 to 100 vinyls/1,000,000 C are included herein and disclosed herein; for example, the vinyl unsaturation can be from a lower limit of 30, 40, 50, 60, 70, 80, or 90 vinyls/1,000,000 C to an upper limit of 35, 45, 55, 6, 75, 85, 95, or 100 vinyls/1,000,000 C. For example, the vinyl unsaturation may be in the range of from 30 to 100, or from 40 to 90, or from 50 to 70, or from 40 to 70 vinyls/1,000,000 C.

The ethylene-based polymer composition useful in embodiments of the invention is further characterized by a ZSVR in the range from at least 2.5 to 15. All individual values and subranges from 2.5 to 15 are included herein and disclosed herein; for example, the ethylene-based polymer composition ZSVR can be from a lower limit of 2.5, 3.5, 4.5, 5.5, 6.5, 7.5, 8.5, 9.5, 10.5, 11.5, 12.5, 13.5, or 14.5 to an upper limit of 3, 4, 5, 6, 7, 8, 9, 10, 11, 12, 13, 14, or 15. For example, the ethylene-based polymer composition ZSVR may be in the range of from 2.5 to 15, or from 4 to 12, or from 3.5 to 13.5, or from 5 to 11.

The ethylene-based polymer composition useful in embodiments of the invention is further characterized by a density in the range of 0.924 to 0.940 g/cm³. All individual values and subranges from 0.924 to 0.940 g/cm³ are included herein and disclosed herein; for example, the ethylene-based polymer composition density can be from a lower limit of 0.924, 0.925, 0.930, or 0.935 g/cm³ to an upper limit of 0.925, 0.930, 0.935, or 0.940 g/cm³. For example, the ethylene-based polymer composition density may be in the range of from 0.924 to 0.940, or from 0.925 to 0.936, or from 0.924 to 0.928, or from 0.932 to 0.936 g/cm³.

The ethylene-based polymer composition useful in embodiments of the invention is further characterized by a melt index (I₂) in the range of from 0.1 to 1 g/10 minutes. All individual values and subranges from 0.1 to 1 g/10 minutes are included herein and disclosed herein; for example, the ethylene-based polymer composition I₂ can be from a lower limit of 0.1, 0.2, 0.3, 0.4, 0.5, 0.6, 0.7, 0.8, or 0.9 g/10 minutes to an upper limit of 0.15, 0.25, 0.35, 0.45, 0.55, 0.65, 0.75, 0.85, 0.95, or 1 g/10 minutes. For example, the ethylene-based polymer composition I₂ may be in the range of from 0.1 to 1, or from 0.2 to 0.8, or from 0.4 to 0.7, or from 0.4 to 0.6 g/10 minutes.

The ethylene-based polymer composition useful in embodiments of the invention is further characterized by a molecular weight distribution (Mw/Mn) in the range of from 2.5 to 10. All individual values and subranges from 2.5 to 10 are included herein and disclosed herein; for example, the ethylene-based polymer composition Mw/Mn can be from a lower limit of 2.5, 3.5, 4.5, 5.5, 6.5, 7.5, 8.5, or 9.5 to an upper limit of 3, 4, 5, 6, 7, 8, 9, or 10. For example, the ethylene-based polymer composition Mw/Mn may be in the range of from 2.5 to 10, or from 2.5 to 7.5, or from 2.75 to 5, or from 2.5 to 4.5.

The ethylene-based polymer composition useful in embodiments of the invention is further characterized by a molecular weight distribution (Mz/Mw) in the range of from 1.5 to 4. All individual values and subranges from 1.5 to 4 are included herein and disclosed herein; for example, the ethylene-based polymer composition Mz/Mw can be from a lower limit of 1.5, 1.75, 2, 2.5, 2.75, 3 or 3.5 to an upper limit of 1.65, 1.85, 2, 2.55, 2.9, 3.34, 3.79, or 4. For example, the ethylene-based polymer composition Mz/Mw may be in the range of from 1.5 to 4, or from 2 to 3, or from 2.5 to 3.5, or from 2.2 to 2.4.

Embodiments of the inventive multi-layered shrink films exhibit one or more properties selected from the group consisting of 45 degree gloss of at least 50%, a total haze of 15% or less, an internal haze of 8% or less, 1% CD Secant Modulus of 43,000 psi or greater, 1% MD Secant Modulus of 38,000 psi or greater, CD shrink tension of at least 0.7 psi, and MD shrink tension of at least 10 psi. The multi-layered shrink film may exhibit any one of these properties, any combination of these properties or alternatively, all of these properties. For example, in one embodiment, the multi-layered film may exhibit a 45 degree gloss of at least 50%, an internal haze of 8% or less, and a 1% CD Secant Modulus of 43,000 psi or greater. In an alternative embodiment, the multi-layered shrink wrap film may exhibit a 1% MD Secant Modulus of 38,000 psi or greater, a CD shrink tension of at least 0.7 psi, and a total haze of 15% or less.

All individual values and subranges of 45 degree gloss of at least 50%, are included herein and disclosed herein; for example, the 45 degree gloss of the multi-layered shrink film can be from a lower limit of 50, 55, 60, 65, or 70%. All individual values and subranges of total haze of 15% or less are included herein and disclosed herein; for example, the total haze of the multi-layered shrink film can be from an upper limit of 10, 12, 14, or 15%. All individual values and subranges of internal haze of 8% or less are included herein and disclosed herein; for example, the internal haze of the multi-layered shrink film can be from an upper limit of 4, 5, 6, 7, or 8%. All individual values and subranges of 1% CD Secant Modulus of 43,000 psi or greater are included herein and disclosed herein; for example, the 1% CD Secant Modulus of the multi-layered shrink film can be from a lower limit of 43,000 psi; or 44,000 psi; or 45,0000 psi; or 50,000 psi; or 55,000 psi. All individual values and subranges of 1% MD Secant Modulus of 38,000 psi or greater are included herein and disclosed herein; for example, the 1% MD Secant Modulus of the multi-layered shrink film can be from a lower limit of 38,000 psi; or 48,000 psi; or 50,0000 psi; or 55,000 psi. All individual values and subranges of CD shrink tension of at least 0.7 psi are included herein and disclosed herein; for example, the CD shrink tension of the multi-layered shrink film can be from a lower limit of 0.7 psi; or 0.8 psi; or 0.9 psi; or 1.0 psi. All individual values and subranges of MD shrink tension of at least 10 psi are included herein and disclosed herein; for example, the MD shrink tension of the multi-layered shrink film can be from a lower limit of 10 psi; or 12 psi; or 15 psi; or 18 psi.

One embodiment of the inventive multi-layered shrink film comprises a total of 3 layers including two skin layers and one core layer; wherein the core layer comprises from 15 to 85 weight percent ethylene-based polymer composition. All individual values and subranges from 15 to 85 weight percent are included herein and disclosed herein; for example, the amount of ethylene-based polymer composition in the core layer can be from a lower limit of 15, 20, 30, 40, 50, 60, or 75 weight percent to an upper limit of 25, 35, 45, 55, 60, 70, 80, or 85 weight percent. For example, the amount of ethylene-based polymer composition in the core layer may be in the range of from 15 to 85 weight percent, or from 20 to 65 weight percent, or from 30 to 80 weight percent, or from 40 to 75 weight percent.

In one embodiment of the inventive multi-layered shrink film, each layer further comprises one or more polymers selected from the group consisting of polypropylene, polyethylene, ethylene/propylene copolymer, ethylene-vinyl acetate (EVA), ethylene/vinyl alcohol copolymer, olefin plastomer and elastomer in quantities such that each layer comprises a total of 92.5 weight percent or greater total polymer. All individual values and subranges from 92.5 to 100 weight percent are included herein and disclosed herein; for example, the total amount of total polymer of each layer can be from a lower limit of 92.5, 94.5, 96.5, 98.5, or 99.5 weight percent to an upper limit of 93, 95, 97, 99, or 100 weight percent. For example, the total amount of total polymer of each layer may be in the range of from 92.5 to 100 weight percent, or from 94 to 98 weight percent, or from 94 to 96 weight percent.

An alternative embodiment of the inventive multi-layered shrink film comprises a total of 3 layers including two skin layers and one core layer; wherein at least one skin layer comprises from 20 to 65 weight percent ethylene-based polymer composition. All individual values and subranges from 20 to 65 weight percent are included herein and disclosed herein; for example, the amount of ethylene-based polymer composition in the at least one skin layer can be from a lower limit of 20, 30, 40, 50 or 60 weight percent to an upper limit of 25, 35, 45, 55, or 65 weight percent. For example, the amount of ethylene-based polymer composition in the at least one skin layer may be in the range of from 20 to 65 weight percent, or from 25 to 55 weight percent, or from 35 to 55 weight percent, or from 45 to 55 weight percent.

In a particular embodiment, the ethylene-based polymer composition used in the multi-layered shrink film is characterized by having a CDC in the range of from 120 to 180, a vinyl unsaturation of from 40 to 60 vinyls /1,000,000 C; a ZSVR in the range from 4 to 8; a density in the range of 0.924 to 0.931 g/cm³, a melt index (I₂) from 0.3 to 0.6 g/10 minutes, a molecular weight distribution (Mw/Mn) in the range of from 2.0 to 3.3, and a molecular weight distribution (Mz/Mw) in the range of from 1.5 to 2.5.

In another embodiment, the ethylene-based polymer composition used in the multi-layered shrink film is characterized by having a CDC in the range of from greater than from 90 to 130, a vinyl unsaturation of from 55 to 70 vinyls/1,000,000 C; a ZSVR in the range from 8 to 12; a density in the range of 0.930 to 0.940 g/cm³, a melt index (I₂) from 0.3 to 0.6 g/10 minutes, a molecular weight distribution (Mw/Mn) in the range of from 2 to 4, and a molecular weight distribution (Mz/Mw) in the range of from 1.5 to 3.

In another embodiment, the ethylene-based polymer composition used in the multi-layered shrink film is characterized by a Total Unsaturation per one million carbon atoms present in the backbone of the ethylene-based polymer composition (Total Unsaturation/1,000,000 C.) less than 120. All individual values and subranges from less than 120 are included herein and disclosed herein; for example, the Total Unsaturation/1,000,000 C. can be from an upper limit of 90, 100, 110, or 120.

The ethylene-based polymer composition may be present in one or more of the layers of the multi-layered shrink film. Where the multi-layered shrink film comprises greater than 3 layers, the central-most layer is referred to as the core layer, the outmost layers are referred to as the skin layers and the remaining layers are referred to as sub-skin layers. In one embodiment, the ethylene-based polymer composition is present in the core layer. In an alternative embodiment, the ethylene-based polymer composition is present in one or more skin layers. In yet another embodiment, the ethylene-based polymer composition is present in one or more sub-skin layers. In yet another embodiment, one or more skin layers comprise from 20 to 60 percent by weight ethylene-based polymer composition. In yet another embodiment, one or more sub-skin layers and/or the core layer comprise from 20 to 80 percent by weight ethylene-based polymer composition.

In certain embodiments, the multi-layered shrink film has a ratio of a thickness of one of the skin layers to a thickness of the core layer from 1:20 to 1:2. In a specific embodiment, the multi-layered shrink film has a thickness of one of the skin layers to a thickness of the core layer from 1:10 to 1:3.

Production of a monolayer shrink film is described in U.S. Patent Publication No. 20110003940, the disclosure of which is incorporated in its entirety herein by reference.

In certain embodiments, both skin layers of the multi-layered shrink film comprise a linear low density polyethylene (LLDPE), other than an ethylene-based polymer composition, having a density from 0.912 to 0.925 g/cm³ and an I₂ from 0.2 to 2 g/10 min. In one embodiment, both skin layers of the multi-layered shrink film comprise an LLDPE, other than the ethylene-based polymer composition, having a density from 0.915 to 0.922 g/cm³ and an I₂ from 0.5 to 1.5 g/10 min. As used herein the term “LLDPE, other than an ethylene-based polymer composition” means an ethylene containing polymer which does not exhibit each of the following characteristics: a Comonomer Distribution Constant in the range of from 75 to 220, a vinyl unsaturation of from 30 to 100 vinyls per one million carbon atoms present in the backbone of the ethylene-based polymer composition; a zero shear viscosity ratio (ZSVR) in the range from at least 2.5 to 15; a density in the range of 0.924 to 0.940 g/cm³, a melt index (I₂) in the range of from 0.1 to 1 g/10 minutes, a molecular weight distribution (Mw/Mn) in the range of from 2.5 to 10, and a molecular weight distribution (Mz/Mw) in the range of from 1.5 to 4

In some embodiments of the invention, the polymer composition comprising one or more layers of the shrink film are treated with one or more stabilizers, for example, antioxidants, such as IRGANOX 1010 and IRGAFOS 168 (Ciba Specialty Chemicals; Glattbrugg, Switzerland). In general, polymers are treated with one or more stabilizers before an extrusion or other melt processes. In other embodiment processes, other polymeric additives include, but are not limited to, ultraviolet light absorbers, antistatic agents, pigments, dyes, nucleating agents, fillers, slip agents, fire retardants, plasticizers, processing aids, lubricants, stabilizers, smoke inhibitors, viscosity control agents and anti-blocking agents. The inventive ethylene-based polymer composition may, for example, comprise less than 10 percent by the combined weight of one or more additives, based on the weight of the inventive ethylene-based polymer composition and such additives.

In some embodiments, one or more antioxidants may further be compounded into the polymers in one or more of the layers of the multi-layered film and the compounded polymers may then be pelletized. For example, the ethylene-based polymer composition may comprise from about 200 to about 600 parts of one or more phenolic antioxidants per one million parts of the ethylene-based polymer. In addition, the ethylene-based polymer composition may comprise from about 800 to about 1200 parts of a phosphite-based antioxidant per one million parts of the ethylene-based polymer.

Other additives which may be added to the polymer composition of any one or more of the layers in the multi-layered shrink film included ignition resistant additives, colorants, extenders, crosslinkers, blowing agents, and plasticizers.

The multi-layered shrink film according to any of the embodiments discussed herein may be produced using any blown film extrusion or co-extrusion processes. Blown film extrusion processes are essentially the same as regular extrusion processes up until the die. The die in a blown film extrusion process is generally an upright cylinder with a circular opening similar to a pipe die. The diameter can be a few centimeters to more than three meters across. The molten plastic is pulled upwards from the die by a pair of nip rolls above the die (from 4 meters to 20 meters or more above the die depending on the amount of cooling required). Changing the speed of these nip rollers will change the gauge (wall thickness) of the film. Around the die sits an air-ring. The air-ring cools the film as it travels upwards. In the center of the die is an air outlet from which compressed air can be forced into the center of the extruded circular profile, creating a bubble. This expands the extruded circular cross section by some ratio (a multiple of the die diameter). This ratio, called the “blow-up ratio” or “BUR” can be just a few percent to more than 200 percent of the original diameter. The nip rolls flatten the bubble into a double layer of film whose width (called the “layflat”) is equal to ½ the circumference of the bubble. This film can then be spooled or printed on, cut into shapes, and heat sealed into bags or other items.

In some instances a blown film line capable of producing a greater than desired number of layers may be used. For example, a five layer line may be used to produce a 3 layered shrink film. In such cases, one or more of the shrink film layers comprises two or more sub-layers, each sub-layer having an identical composition.

In one embodiment, the instant invention provides a multi-layered shrink film, in accordance with any of the preceding embodiments, except that each layer further comprises one or more polymers selected from the group consisting of polypropylene, polyethylene, ethylene/propylene copolymer, ethylene-vinyl acetate (EVA), ethylene/vinyl alcohol copolymer, olefin plastomer and elastomer in quantities such that each layer comprises a total of from 92.5 to 100 percent by weight total polymer. In an alternative embodiment, the instant invention provides a multi-layered shrink film, in accordance with any of the preceding embodiments, except that the shrink film comprises a total of 3 layers including two skin layers and one core layer; and wherein the core layer comprises 15 to 85 weight percent ethylene-based polymer composition.

In an alternative embodiment, the instant invention provides a multi-layered shrink film, in accordance with any of the preceding embodiments, except that the shrink film comprises a total of 3 layers including two skin layers and one core layer; wherein at least one skin layer comprises 20 to 65 weight percent ethylene-based polymer composition. In an alternative embodiment, the instant invention provides a multi-layered shrink film, in accordance with any of the preceding embodiments, except that the film is produced using a blown film co-extrusion process. In an alternative embodiment, the instant invention provides a multi-layered shrink film, in accordance with any of the preceding embodiments, except that the ethylene-based polymer composition is characterized by having a Comonomer Distribution Constant in the range of from 120 to 180, a vinyl unsaturation of from 40 to 60 vinyls per one million carbon atoms present in the backbone of the ethylene-based polymer composition; a ZSVR in the range from 4 to 8, a density in the range of 0.924 to 0.931 g/cm³, a melt index (I₂) from 0.3 to 0.6 g/10 minutes, a molecular weight distribution (Mw/Mn) in the range of from 2.0 to 3.3, and a molecular weight distribution (Mz/Mw) in the range of from 1.5 to 2.5. In an alternative embodiment, the instant invention provides a multi-layered shrink film, in accordance with any of the preceding embodiments, except that the ethylene-based polymer composition is characterized by having a Comonomer Distribution Constant in the range of from 90 to 130, a vinyl unsaturation of from 55 to 70 vinyls per one million carbon atoms present in the backbone of the ethylene-based polymer composition; a zero shear viscosity ratio (ZSVR) in the range from 8 to 12; a density in the range of 0.93 to 0.94 g/cm³, a melt index (1₂) from 0.3 to 0.6 g/10 minutes, a molecular weight distribution (Mw/Mn) in the range of from 2 to 4, and a molecular weight distribution (Mz/Mw) in the range of from 1.5 to 3. In an alternative embodiment, the instant invention provides a multi-layered shrink film, in accordance with any of the preceding embodiments, except that the ratio of a thickness of one of the skin layers to a thickness of the core layer is from 1:20 to 1:2. In an alternative embodiment, the instant invention provides a multi-layered shrink film, in accordance with any of the preceding embodiments, except that the ratio of a thickness of one of the skin layers to a thickness of the core layer is from 1:10 to 1:3. In an alternative embodiment, the instant invention provides a multi-layered shrink film, in accordance with any of the preceding embodiments, except that both skin layers comprise LLDPE having a density from 0.912 to 0.925 g/cm³ and an I₂ from 0.2 to 2 g/10min. In an alternative embodiment, the instant invention provides a multi-layered shrink film, in accordance with any of the preceding embodiments, except that both skin layers comprise LLDPE having a density from 0.915 to 0.922 g/cm³ and an I₂ from 0.5 to 1.5 g/10min. In an alternative embodiment, the instant invention provides a multi-layered shrink film, in accordance with any of the preceding embodiments, except that the ethylene-based polymer composition has an I₂ of from 0.3 to 0.8 g/10 min and density from 0.930 to 0.940 g/cm³.

### EXAMPLES

The following examples illustrate the present invention but are not intended to limit the scope of the invention.

Production of the Ethylene-Based Polymer Compositions used in the Inventive Examples

Inventive Compositions Examples (Inv. Comp. Ex.) 1-3 were ethylene-based polymer compositions which were made in dual solution polymerization reactors in series under the conditions shown in Tables 1-3. Table 4 summarizes the catalysts and catalyst components referenced in Table 3. Inventive Composition Example 4 was an ethylene-based polymer composition made in dual solution polymerization reactors in series under similar conditions.

TABLE 1

| | Inv. Comp. | Inv. Comp | Inv. Comp |
|---|---|---|---|
| REACTOR FEEDS | Ex. 1 | Ex. 2 | Ex. 3 |
| Primary Reactor Feed Temperature, ° C. | 35.0 | 35.0 | 35.0 |
| Primary Reactor Total Solvent Flow, lbs/h | 790 | 802 | 1107 |
| Primary Reactor Fresh Ethylene Flow, lbs/h | 151 | 154 | 160 |
| Primary Reactor Total Ethylene Flow, lbs/h | 158 | 160 | 169 |
| Comonomer Type | 1-octene | 1-octene | 1-octene |
| Primary Reactor Fresh Comonomer Flow lbs/h, | 0.0 | 0.0 | 0.0 |
| Primary Reactor Total Comonomer Flow lbs/h, | 11.5 | 5.1 | 9.0 |
| Primary Reactor Feed Solvent/Ethylene Ratio | 5.23 | 5.22 | 6.93 |
| Primary Reactor Fresh Hydrogen Flow, Sccm | 3,927 | 4,212 | 2,323 |
| Primary Reactor Hydrogen mole % | 0.40 | 0.42 | 0.22 |
| Secondary Reactor Feed Temperature, ° C. | 35.2 | 35.3 | 34.9 |
| Secondary Reactor Total Solvent Flow, lbs/h | 437.7 | 441.7 | 380.9 |
| Secondary Reactor Fresh Ethylene Flow, lbs/h | 142.0 | 143.0 | 142.8 |
| Secondary Reactor Total Ethylene Flow, lbs/h | 145.5 | 146.5 | 145.8 |
| Secondary Reactor Fresh Comonomer Flow, | 11.8 | 6.4 | 7.6 |
| lbs/h | | | |
| Secondary Reactor Total Comonomer Flow, | 18.1 | 9.2 | 10.7 |
| lbs/h | | | |
| Secondary Reactor Feed Solvent/Ethylene Ratio | 3.08 | 3.09 | 2.67 |
| Secondary Reactor Fresh Hydrogen Flow, Sccm | 1,163 | 854 | 5,525 |
| Secondary Reactor Hydrogen Mole % | 0.126 | 0.092 | 0.595 |
| Fresh Comonomer injection location | Secondary | Secondary | Secondary |
| | Reactor | Reactor | Reactor |
| Ethylene Split, wt % | 52.0 | 52.2 | 53.6 |

TABLE 2

| REACTION | Inv. Comp. Ex. 1 | Inv. Comp. Ex. 2 | Inv. Comp. Ex. 3 |
|---|---|---|---|
| Primary Reactor Control Temperature | 160° C. | 160° C. | 180° C. |
| Primary Reactor Pressure | 725 psig | 725 psig | 725 psig |
| Primary Reactor Ethylene Conversion, | 74.9 wt % | 74.6 wt % | 70.7 wt % |
| Primary Reactor FTnIR Outlet [C2] | 25.2 g/L | 25.5 g/L | 22.8 g/L |
| Primary Reactor 10log Victosity | 3.21 log(cP) | 3.18 log(cP) | 2.65 log(cP) |
| Primary Reactor Polymer Concentration | 12.8 wt % | 12.6 wt % | 9.5 wt % |
| Primary Reactor Exchanger's Heat | 11.2 | 11.0 | 13.2 |
| Transfer Coefficient, BTU/(hr ft2 ° F.) | | | |
| Primary Reactor Polymer Residence Time | 0.36 hrs | 0.35 hrs | 0.26 hrs |
| Secondary Reactor Control Temperature | 190° C. | 190° C. | 190° C. |
| Secondary Reactor Pressure | 725 psig | 725 psig | 725 psig |
| Secondary Reactor Ethylene Conversion | 89.9 wt % | 91.5 wt % | 88.3 wt % |
| Secondary Reactor FTnIR Outlet [C2] | 7.5 g/L | 6.3 g/L | 7.7 g/L |
| Secondary Reactor 10log Viscosity | 3.00 log(cP) | 2.99 log(cP) | 2.68 log(cP) |
| Secondary Reactor Polymer Concentration | 20.6 wt % | 19.8 wt % | 17.3 wt % |
| Secondary Reactor Exchanger's Heat | 42.6 | 44.7 | 37.9 |
| Transfer Coefficient, BTU/(hr ft2 ° F.) | | | |
| Secondary Reactor Polymer Residence | 0.13 | 0.13 | 0.11 |
| Time, hrs | | | |
| Overall Ethylene conversion by vent, wt % | 93.9 | 94.9 | 92.4 |

TABLE 3

| CATALYST | Inv. Comp. Ex. 1 | Inv. Comp. Ex. 2 | Inv. Comp. Ex. 3 |
|---|---|---|---|
| Primary Reactor | | | |
| Catalyst Type | CAT-A | CAT-A | CAT-A |
| Catalyst Flow, lbs/hr | 0.50 | 0.48 | 1.01 |
| Catalyst Concentration, ppm | 49 | 49 | 49 |
| Catalyst Efficiency, Mlbs poly/lb Zr | 5.0 | 5.2 | 2.4 |
| Catalyst Metal Molecular Weight, g/mole | 90.86 | 90.86 | 90.86 |
| Co-Catalyst-1 Molar Ratio | 2.5 | 3.2 | 2.5 |
| Co-Catalyst-1 Type | RIBS-2 | RIBS-2 | RIBS-2 |
| Co-Catalyst-1 Flow, lbs/hr | 0.17 | 0.20 | 0.33 |
| Co-Catalyst-1 Concentration, ppm | 4,865 | 4,865 | 4,865 |
| Co-Catalyst-2 Molar Ratio | 10.1 | 10.5 | 10.0 |
| Co-Catalyst-2 Type | MMAO-3A | MMAO-3A | MMAO-3A |
| Co-Catalyst-2 Flow, lbs/hr | 0.20 | 0.20 | 0.41 |
| Co-Catalyst-2 Concentration, ppm | 359 | 359 | 359 |
| Secondary Reactor | | | |
| Catalyst Type | CAT-A | CAT-A | CAT-A |
| Catalyst Flow, lbs/hr | 4.4 | 5.4 | 4.1 |
| Catalyst Concentration, ppm | 49 | 49 | 49 |
| Catalyst Efficiency, Mlbs poly/lb Zr | 0.90 | 0.70 | 0.94 |
| Co-Catalyst-1 Molar Ratio | 1.5 | 2.0 | 2.0 |
| Co-Catalyst-1 Type | RIBS-2 | RIBS-2 | RIBS-2 |
| Co-Catalyst-1 Flow, lbs/hr | 0.86 | 1.4 | 1.1 |
| Co-Catalyst-1 Concentration, ppm | 4,865 | 4,865 | 4,865 |
| Co-Catalyst-2 Molar Ratio | 10.0 | 8.0 | 9.0 |
| Co-Catalyst-2 Type | MMAO-3A | MMAO-3A | MMAO-3A |
| Co-Catalyst-2 Flow, lbs/hr | 1.8 | 1.7 | 1.5 |
| Co-Catalyst-2 Concentration, ppm | 359 | 359 | 359 |

TABLE 4

| | CAS Name |
|---|---|
| CAT-A | Zirconium, [2,2′″-[1,3-propanediylbis(oxy-κO)]- |
| | bis[3″,5,5″-tris(1,1-dimethylethyl)-5′-methyl- |
| | [1,1′:3′,1″-terphenyl]-2′-olato-κO]]dimethyl-, (OC-6-33)- |
| RIBS-2 | Amines, bis(hydrogenated tallow alkyl)methyl, |
| | tetrakis(pentafluorophenyl)borate(1-) |
| MMAO- | Aluminoxanes, iso-Bu Me, branched, cyclic and linear; |
| 3A | modified methyl aluminoxane |

Various properties of Inventive Composition Examples 1-4 are shown in Tables 5-14.

TABLE 5

| | I₂ (g/10 min) | I₁₀ (g/10 min) | I₁₀/I₂ | Density (g/cc) |
|---|---|---|---|---|
| Inv. Comp. Ex. 1 | 0.46 | 4.4 | 9.6 | 0.9289 |
| Inv. Comp. Ex. 2 | 0.51 | 4.9 | 9.5 | 0.9356 |
| Inv. Comp. Ex. 3 | 0.44 | 4.8 | 10.8 | 0.9346 |
| Inv. Comp. Ex. 4 | 0.46 | 4.9 | 10.6 | 0.9357 |

TABLE 6

| Inv. Comp | Tₘ | Heat of Fusion | % | T_{c} |
|---|---|---|---|---|
| Example | (° C.) | (J/g) | Cryst. | (° C.) |
| 1 | 122.1 | 165.0 | 56.5 | 108.4 |
| 2 | 125.8 | 179.2 | 61.4 | 113.0 |
| 3 | 124.6 | 175.9 | 60.2 | 112.2 |
| 4 | 124.7 | 179.3 | 61.4 | 112.2 |

TABLE 7
(DMS viscosity)

| | Viscosity in Pa-s | | | |
|---|---|---|---|---|
| Frequency | Inv. Comp. | Inv. Comp. | Inv. Comp. | Inv. Comp. |
| (rad/s) | Ex. 1 | Ex. 2 | Ex. 3 | Ex. 4 |
| 0.10 | 22,974 | 20,965 | 26,039 | 24,281 |
| 0.16 | 20,600 | 18,828 | 22,706 | 21,233 |
| 0.25 | 18,288 | 16,730 | 19,616 | 18,386 |
| 0.40 | 16,066 | 14,723 | 16,796 | 15,794 |
| 0.63 | 14,045 | 12,874 | 14,329 | 13,487 |
| 1.00 | 12,214 | 11,198 | 12,179 | 11,488 |
| 1.58 | 10,629 | 9,702 | 10,333 | 9,768 |
| 2.51 | 9,187 | 8,378 | 8,752 | 8,287 |
| 3.98 | 7,911 | 7,206 | 7,394 | 7,012 |
| 6.31 | 6,786 | 6,167 | 6,219 | 5,911 |
| 10.00 | 5,775 | 5,238 | 5,197 | 4,950 |
| 15.85 | 4,833 | 4,401 | 4,299 | 4,112 |
| 25.12 | 4,030 | 3,664 | 3,526 | 3,379 |
| 39.81 | 3,315 | 3,012 | 2,859 | 2,748 |
| 63.10 | 2,688 | 2,444 | 2,291 | 2,210 |
| 100.00 | 2,148 | 1,957 | 1,816 | 1,757 |
| Viscosity | 10.69 | 10.71 | 14.34 | 13.82 |
| 0.1/100 | | | | |

TABLE 8
(DMS tan delta)

| Freq. | Inv. Comp. | Inv. Comp. | Inv. Comp. | Inv. Comp. |
|---|---|---|---|---|
| (rad/sec) | Ex. 1 | Ex. 2 | Ex. 3 | Ex. 4 |
| 0.10 | 2.80 | 2.89 | 2.16 | 2.19 |
| 0.16 | 2.51 | 2.58 | 1.98 | 2.00 |
| 0.25 | 2.30 | 2.35 | 1.85 | 1.87 |
| 0.40 | 2.15 | 2.17 | 1.75 | 1.77 |
| 0.63 | 2.03 | 2.04 | 1.68 | 1.70 |
| 1.00 | 1.94 | 1.94 | 1.62 | 1.65 |
| 1.58 | 1.86 | 1.86 | 1.58 | 1.60 |
| 2.51 | 1.79 | 1.77 | 1.53 | 1.55 |
| 3.98 | 1.71 | 1.69 | 1.48 | 1.50 |
| 6.31 | 1.62 | 1.60 | 1.41 | 1.44 |
| 10.00 | 1.52 | 1.50 | 1.34 | 1.36 |
| 15.85 | 1.41 | 1.40 | 1.26 | 1.28 |
| 25.12 | 1.30 | 1.29 | 1.17 | 1.20 |
| 39.81 | 1.20 | 1.19 | 1.09 | 1.12 |
| 63.10 | 1.09 | 1.08 | 1.01 | 1.04 |
| 100.00 | 0.98 | 0.99 | 0.93 | 0.96 |

TABLE 9
(Complex Modulus and Phase Angle)

| | Inv. | | Inv. | | Inv. | | Inv. |
|---|---|---|---|---|---|---|---|
| | Comp Ex. | | Comp Ex. | | Comp Ex. | | Comp Ex. |
| G* | 1 Phase | G* | 2 Phase | G* | 3 Phase | G* | 4 Phase |
| (Pa) | Angle | (Pa) | Angle | (Pa) | Angle | (Pa) | Angle |
| 2.30E+03 | 70.35 | 2.10E+03 | 70.92 | 2.60E+03 | 65.12 | 2.43E+03 | 65.42 |
| 3.26E+03 | 68.32 | 2.98E+03 | 68.80 | 3.60E+03 | 63.19 | 3.37E+03 | 63.49 |
| 4.59E+03 | 66.54 | 4.20E+03 | 66.92 | 4.93E+03 | 61.57 | 4.62E+03 | 61.92 |
| 6.40E+03 | 65.03 | 5.86E+03 | 65.28 | 6.69E+03 | 60.24 | 6.29E+03 | 60.59 |
| 8.86E+03 | 63.80 | 8.12E+03 | 63.92 | 9.04E+03 | 59.22 | 8.51E+03 | 59.59 |
| 1.22E+04 | 62.74 | 1.12E+04 | 62.75 | 1.22E+04 | 58.38 | 1.15E+04 | 58.74 |
| 1.68E+04 | 61.78 | 1.54E+04 | 61.70 | 1.64E+04 | 57.65 | 1.55E+04 | 58.01 |
| 2.31E+04 | 60.76 | 2.10E+04 | 60.60 | 2.20E+04 | 56.82 | 2.08E+04 | 57.22 |
| 3.15E+04 | 59.63 | 2.87E+04 | 59.40 | 2.94E+04 | 55.88 | 2.79E+04 | 56.30 |
| 4.28E+04 | 58.26 | 3.89E+04 | 58.00 | 3.92E+04 | 54.69 | 3.73E+04 | 55.16 |
| 5.77E+04 | 56.63 | 5.24E+04 | 56.34 | 5.20E+04 | 53.23 | 4.95E+04 | 53.75 |
| 7.66E+04 | 54.69 | 6.98E+04 | 54.41 | 6.81E+04 | 51.50 | 6.52E+04 | 52.08 |
| 1.01E+05 | 52.51 | 9.20E+04 | 52.23 | 8.86E+04 | 49.56 | 8.49E+04 | 50.23 |
| 1.32E+05 | 50.09 | 1.20E+05 | 49.85 | 1.14E+05 | 47.46 | 1.09E+05 | 48.18 |
| 1.70E+05 | 47.47 | 1.54E+05 | 47.31 | 1.45E+05 | 45.24 | 1.39E+05 | 46.01 |
| 2.15E+05 | 44.54 | 1.96E+05 | 44.70 | 1.82E+05 | 43.00 | 1.76E+05 | 43.72 |

TABLE 10
(melt strength)

| Sample | Melt Strength (cN) |
|---|---|
| Inv. Comp Example 1 | 5.9 |
| Inv. Comp Example 2 | 5.1 |
| Inv. Comp Example 3 | 5.6 |
| Inv. Comp Example 4 | 5.5 |

TABLE 11
(Conventional GPC)

| | Mw | Mn | | Mz | |
|---|---|---|---|---|---|
| | (g/mol) | (g/mol) | Mw/Mn | (g/mol) | Mz/Mw |
| Inv. Comp Ex. 1 | 112,195 | 43,772 | 2.56 | 224,275 | 2.00 |
| Inv. Comp Ex. 2 | 108,569 | 42,905 | 2.53 | 219,204 | 2.02 |
| Inv. Comp Ex. 3 | 110,087 | 34,912 | 3.15 | 259,572 | 2.36 |
| Inv. Comp Ex. 4 | 112,074 | 40,018 | 2.80 | 252,068 | 2.25 |

TABLE 12

| | M_{w} | ZSV | Log | Log | |
|---|---|---|---|---|---|
| | (g/mol) | (Pa-s) | (M_{w in g/mol}) | (ZSV in Pa-s) | ZSVR |
| Inv. Comp | 112,195 | 37,362 | 5.050 | 4.572 | 6.03 |
| Ex. 1 | | | | | |
| Inv. Comp | 108,569 | 33,289 | 5.036 | 4.522 | 6.06 |
| Ex. 2 | | | | | |
| Inv. Comp | 110,087 | 44,553 | 5.042 | 4.649 | 7.70 |
| Ex. 3 | | | | | |
| Inv. Comp | 112,074 | 53,720 | 5.050 | 4.730 | 8.70 |
| Ex. 4 | | | | | |

TABLE 13

| | | | | | Total |
|---|---|---|---|---|---|
| | Vinylene/ | Trisubstituted/ | Vinyl/ | Vinylidene/ | Unsaturation/ |
| | 1,000,000 C | 1,000,000 C | 1,000,000 C | 1,000,000 C | 1,000,000 C |
| Inv. Comp Ex. 1 | 4 | 1 | 48 | 4 | 58 |
| Inv. Comp Ex. 2 | 5 | 1 | 46 | 4 | 56 |
| Inv. Comp Ex. 3 | 4 | 1 | 62 | 4 | 71 |
| Inv. Comp Ex. 4 | 5 | 3 | 62 | 5 | 74 |

TABLE 14

| | | | | | CDC |
|---|---|---|---|---|---|
| | | | | | (Comonomer |
| | Comonomer | Stdev | HalfWidth | HalfWidth/ | Dist. |
| | Dist. Index | (° C.) | (° C.) | Stdev | Constant) |
| Inv. Comp | 0.567 | 7.276 | 2.880 | 0.396 | 143.1 |
| Ex. 1 | | | | | |
| Inv. Comp | 0.950 | 5.513 | 3.328 | 0.604 | 157.4 |
| Ex. 2 | | | | | |
| Inv. Comp | 0.651 | 5.359 | 3.179 | 0.593 | 109.7 |
| Ex. 3 | | | | | |
| Inv. Comp | 0.678 | 4.747 | 3.333 | 0.702 | 96.6 |
| Ex. 4 | | | | | |

### Production of Comparative Film Example 1 and Inventive Film Examples 1-8

Comparative Film Example 1 and Inventive Film Examples 1-8 were made on the Alpine American 7-Layer co-extrusion blown film line. This line consists of seven 50 mm 30:1 grooved feed extruders utilizing barrier screws and a 250 mm (9.9 inches) co-ex die. The die was machined with the following layer distribution: 15/15/13/14/13/15/15 and is equipped with internal bubble cooling. Each extruder is equipped with a Maguire four-component blender. The proper die pin was used to achieve a die gap of 2 mm (78 mil). Gauge control was achieved through the Alpine auto-profile air ring system which utilizes a non-contact NDC back scatter gauge measurement system. A Brampton Engineering 64″ dual turret stacked winder was used to wind the film. The same extrusion temperature profile was set on all seven extruders: Zone 1 70° F./Zone 2 380° F./Zone 3 380° F./Zone 4 380° F./Zone 5 380° F./Zone 6 450° F./Zone 7 450° F./Zone 8 450° F./Die 450° F. Each of Inventive Film Examples (Inv. Film Ex.) 1 - 8 and Comparative Film Example (Comp. Film Ex.) 1 was a three layer shrink film. Tables 16 and 17 below summarizes the optical and mechanical properties of Comparative Film Example 1 and Inventive Film Examples 1-8. Table 20 provides the density and I₂ for each of the polymer compositions, other than the Inventive Compositions, used in the Inventive and Comparative Film Examples.

TABLE 16

| | Comp. Film | | Inv. Film | | Inv. Film | | Inv. Film | |
|---|---|---|---|---|---|---|---|---|
| | Ex. 1 | | Ex. 1 | | Ex. 2 | | Ex. 3 | |
| Comp. of Skin | 100% LDPE-1 | | 100% LDPE-1 | | 100% LDPE-1 | | 100% LDPE-1 | |
| Layers | | | | | | | | |
| Comp. of Core | 60% LDPE132I; | | 60% LDPE132I; | | 60% LDPE132I; | | 20% LDPE132I; | |
| layer | 40% ELITE | | 40% Inv. Comp. | | 40% Inv. Comp. | | 80% Inv. Comp. | |
| | 5111G | | Ex. 1 | | Ex. 2 | | Ex. 3 | |
| BUR | 3.2 | | 3.2 | | 3.2 | | 3.2 | |
| Layer Ratio | 10/80/10 | | 10/80/10 | | 10/80/10 | | 10/80/10 | |
| Target | 2.25 | mil | 2.25 | mil | 2.25 | mil | 2.25 | mil |
| Thickness | | | | | | | | |
| Gloss @ | 64.3 | | 66.1 | | 65.8 | | 63.3 | |
| 45°, % | | | | | | | | |
| Actual | 2.16 | mil | 2.18 | mil | 2.21 | mil | 2.18 | mil |
| Thickness, | | | | | | | | |
| Total Haze, % | 8.5 | | 8.2 | | 9.6 | | 11.7 | |
| Internal Haze | 2.16 | | 2.18 | | 2.21 | | 2.18 | |
| Thickness, mil | | | | | | | | |
| Internal Haze, % | 2.3 | | 2.5 | | 4.1 | | 5.7 | |
| 1% CD Secant | 44206 | | 47884 | | 59693 | | 66676 | |
| Modulus, psi | | | | | | | | |
| 2% CD Secant | 37176 | | 39947 | | 49368 | | 54641 | |
| Modulus, psi | | | | | | | | |
| 1% MD Secant | 39526 | | 41613 | | 49272 | | 60855 | |
| Modulus, psi | | | | | | | | |
| 2% MD Secant | 34039 | | 35792 | | 41920 | | 50800 | |
| Modulus, psi | | | | | | | | |
| CD Ultimate | 3786 | | 4359 | | 3507 | | 4399 | |
| Tensile, psi | | | | | | | | |
| CD Tensile Peak | 8.4 | | 9.6 | | 8.3 | | 9.6 | |
| Load, lb-f | | | | | | | | |
| CD Ultimate | 585 | | 670 | | 628 | | 707 | |
| Elongation, % | | | | | | | | |
| CD Tensile | 12 | | 11 | | 11 | | 11 | |
| Yield Strain, % | | | | | | | | |
| CD Tensile Yield | 1915 | | 2080 | | 2293 | | 2660 | |
| Strength, psi | | | | | | | | |
| CD Tensile | 2.21 | | 2.12 | | 2.36 | | 2.18 | |
| Thickness, mil | | | | | | | | |
| MD Ultimate | 4266 | | 4119 | | 3692 | | 4862 | |
| Tensile, psi | | | | | | | | |
| MD Tensile Peak | 9.6 | | 9.1 | | 8.6 | | 10.7 | |
| Load, lb-f | | | | | | | | |
| MD Ultimate | 345 | | 320 | | 241 | | 579 | |
| Elongation, % | | | | | | | | |
| MD Tensile | 11 | | 12 | | 11 | | 15 | |
| YieldStrain, % | | | | | | | | |
| MD Tensile Yield | 1847 | | 2042 | | 2163 | | 2474 | |
| Strength, psi | | | | | | | | |
| MD Tensile | 2.2 | | 2.2 | | 2.3 | | 2.2 | |
| Thickness, mil | | | | | | | | |
| CD Free Shrink | 30.1 | | 26.2 | | 32.1 | | 23.2 | |
| 140° C., % | | | | | | | | |
| MD Free Shrink | 80.3 | | 80.3 | | 78.3 | | 73.4 | |
| 140° C., % | | | | | | | | |
| CD Free Shrink | 32.1 | | 27.2 | | 34.1 | | 25.2 | |
| 150° C., % | | | | | | | | |
| MD Free Shrink | 81.3 | | 80.3 | | 79.3 | | 75.4 | |
| 150° C., % | | | | | | | | |
| CD Tear, g | 1011 | | 480 | | 441 | | 831 | |
| MD Tear, g | 219 | | 181 | | 265 | | 144 | |
| Dart A, g | 220 | | 184 | | 169 | | 157 | |
| CD Shrink | 0.51 | | 1.02 | | 1.12 | | 0.82 | |
| Tension, psi | | | | | | | | |
| MD Shrink | 24 | | 29 | | 22 | | 10 | |
| Tension, psi | | | | | | | | |
| Puncture | 106 | ft*lbf/in³ | 93 | ft*lbf/in³ | 67 | ft*lbf/in³ | 60 | ft*lbf/in³ |

TABLE 17

| | Inv. Film | | Inv. Film | | Inv. Film | | Inv. Film | | Inv. Film | |
|---|---|---|---|---|---|---|---|---|---|---|
| | Ex. 4 | | Ex. 5 | | Ex. 6 | | Ex. 7 | | Ex. 8 | |
| Composition | 50% LDPE-1; | | 100% LDPE-1 | | 100% LDPE-1 | | 100% LDPE-1 | | 100% LDPE-1 | |
| of Skin | 30% Inv. | | | | | | | | | |
| Layers | Comp. Ex. 4; | | | | | | | | | |
| | 17% LDPE-2 | | | | | | | | | |
| Composition | 60% LDPE132I; | | 60% LDPE132I; | | 60% LDPE132I/ | | 20% LDPE132I/ | | 40% LDPE132I/ | |
| of Core layer | 20% ELITE | | 40% Inv. Comp. | | 40% Inv. Comp. | | 80% Inv. Comp. | | 60% Inv. Comp. | |
| | 5111G; 20% | | Ex. 1 | | Ex. 2 | | Ex. 1 | | Ex. 3 | |
| | Inv. Comp. | | | | | | | | | |
| | Ex. 4 | | | | | | | | | |
| BUR | 3.0 | | 3.2 | | 3.2 | | 3.2 | | 3.2 | |
| Layer Ratio | 10/80/10 | | 10/80/10 | | 10/80/10 | | 10/80/10 | | 10/80/10 | |
| Target | 2.25 | mil | 2.1 | mil | 2.1 | mil | 2.1 | mil | 1.5 | mil |
| Thickness | | | | | | | | | | |
| Gloss @ | 52.9% | | 65.1% | | 66.7% | | 63.7% | | 59.8% | |
| 45° | | | | | | | | | | |
| Actual | 2.17 | mil | 2.07 | mil | 2.03 | mil | 2.02 | mil | 1.44 | mil |
| Thickness | | | | | | | | | | |
| Total Haze | 12.6% | | 8.0% | | 9.0% | | 9.7% | | 9.6% | |
| Internal Haze | 2.17 | | 2.07 | | 2.03 | | 2.02 | | 1.44 | |
| Thickness, | | | | | | | | | | |
| mil | | | | | | | | | | |
| Internal Haze | 4.0% | | 2.2% | | 3.6% | | 3.6% | | 2.4% | |
| 1% CD Secant | 51792 | | 50924 | | 60504 | | 54408 | | 67712 | |
| Modulus, psi | | | | | | | | | | |
| 2% CD Secant | 42794 | | 42394 | | 50126 | | 45308 | | 55361 | |
| Modulus, psi | | | | | | | | | | |
| 1% MD Secant | 45147 | | 43716 | | 49996 | | 48616 | | 56336 | |
| Modulus, psi | | | | | | | | | | |
| 2% MD Secant | 38065 | | 37472 | | 42503 | | 41316 | | 47693 | |
| Modulus, psi | | | | | | | | | | |
| CD Ultimate | 4312 | | 4371 | | 3455 | | 5263 | | 3875 | |
| Tensile, psi | | | | | | | | | | |
| CD Tensile | 9.7 | lb-f | 9.4 | lb-f | 8.1 | lb-f | 10.9 | lb-f | 5.8 | lb-f |
| Peak Load | | | | | | | | | | |
| CD Ultimate | 639% | | 669% | | 614% | | 719% | | 660% | |
| Elongation | | | | | | | | | | |
| CD Tensile | 12% | | 11% | | 12% | | 13% | | 10% | |
| Yield Strain | | | | | | | | | | |
| CD Tensile | 2213 | | 2118 | | 2249 | | 2278 | | 2509 | |
| Yield | | | | | | | | | | |
| Strength, psi | | | | | | | | | | |
| CD Tensile | 2.25 | mil | 2.15 | mil | 2.35 | mil | 2.06 | mil | 1.49 | mil |
| Thickness | | | | | | | | | | |
| MD Ultimate | 4650 | | 4144 | | 3966 | | 5867 | | 4507 | |
| Tensile, psi | | | | | | | | | | |
| MD Tensile | 10.5 | lb-f | 8.7 | lb-f | 9.2 | lb-f | 11.8 | lb-f | 6.7 | lb-f |
| Peak Load | | | | | | | | | | |
| MD Ultimate | 373% | | 284% | | 301% | | 614% | | 338% | |
| Elongation | | | | | | | | | | |
| MD Tensile | 11% | | 11% | | 14% | | 15% | | 16% | |
| Yield Strain | | | | | | | | | | |
| MD Tensile | 2120 | | 1980 | | 2142 | | 2160 | | 2365 | |
| Yield | | | | | | | | | | |
| Strength, psi | | | | | | | | | | |
| MD Tensile | 2.25 | mil | 2.11 | mil | 2.30 | mil | 2.01 | mil | 1.52 | mil |
| Thickness | | | | | | | | | | |
| CD Free | 21.8 | | 18.3 | | 37 | | 21.3 | | 22.2 | |
| Shrink | | | | | | | | | | |
| 140° C., % | | | | | | | | | | |
| MD Free | 77.3 | | 80.3 | | 77.4 | | 75.4 | | 80.3 | |
| Shrink | | | | | | | | | | |
| 140° C., % | | | | | | | | | | |
| CD Free Shrink | 21.8 | | 22.2 | | 37 | | 23.2 | | 23.2 | |
| 150° C., % | | | | | | | | | | |
| MD Free Shrink | 80.3 | | 81.3 | | 79.3 | | 76.4 | | 82.3 | |
| 150° C., % | | | | | | | | | | |
| CD Tear, g | 654 | | 473 | | 344 | | 958 | | 451 | |
| MD Tear, g | 206 | | 198 | | 216 | | 179 | | 164 | |
| Dart A, g | 196 | | 184 | | 160 | | 157 | | 103 | |
| CD Shrink | 1.0 | | 0.91 | | 1.3 | | 0.90 | | 1.05 | |
| Tension, psi | | | | | | | | | | |
| MD Shrink | 22 | | 28 | | 20 | | 11 | | 24 | |
| Tension, psi | | | | | | | | | | |
| Puncture | 83 | ft*lbf/in³ | 93 | ft*lbf/in³ | 62 | ft*lbf/in³ | 107 | ft*lbf/in³ | 64 | ft*lbf/in³ |

Each of Inventive Film Examples 9-12 and Comparative Film Example 2 were made on a Reifenhauser three-layer co-extrusion blown film line under the following conditions: die gap=1.8 mm; output=140 kg/h; and BUR=3.5. Temperature conditions (° C.) of the blown film line are shown in Table 18.

TABLE 18

| | Extruder A | Extruder B | Extruder C |
|---|---|---|---|
| Inv. Film Ex. 9 | 232 | 241 | 237 |
| Comp. Film Ex. 2 | 232 | 238 | 229 |
| Inv. Film Ex. 10 | 232 | 234 | 231 |
| Inv. Film Ex. 11 | 233 | 234 | 227 |
| Inv. Film Ex. 12 | 233 | 233 | 225 |

Table 19 provides the compositional information for Inventive Film Examples 9-12 and Comparative Film Example 2.

TABLE 19

| | Inv. Film | Comp. Film | Inv. Film | Inv. Film | Inv. Film |
|---|---|---|---|---|---|
| | Ex. 9 | Ex. 2 | Ex. 10 | Ex. 11 | Ex. 12 |
| First skin | LLDPE-1 | 33% LLDPE-1; 33% | 80% LLDPE-1; | DOWLEX | ELITE |
| layer | | Inv. Comp. Ex. 4; | 20% LD132I | 2045G | 5400G |
| | | 33% LDPE132I | | | |
| Core layer | 50% Inv. | 33% LLDPE-1; 3% | 50% Inv. | 50% Inv. | 50% Inv. |
| | Comp. Ex. 4; | Inv. Comp. Ex. 4; | Comp. Ex. 4 | Comp. Ex. 4; | Comp. Ex. 4; |
| | 50% LD132I | 33% LDPE132I | 50% LD132I | 50% LD132I | 50% LD132I |
| Second skin | LLDPE-1 | 33% LLDPE-1; 33% | 80% LLDPE-1; | DOWLEX | ELITE |
| layer | | Inv. Comp. Ex. 4; | 20% LD132I | 2045G | 5400G |
| | | 33% LDPE132I | | | |
| Target | 3.94 mil | 3.94 mil | 3.94 mil | 3.94 mil | 3.94 mil |
| thickness | | | | | |
| Layer ratio | 1/4/1 | 1/4/1 | 1/4/1 | 1/4/1 | 1/4/1 |

Table 20 provides the density and melt index (I₂) for polymer compositions (other than the Inventive Composition Examples) used in the Inventive Film Examples and Comparative Film Examples.

TABLE 20

| | I₂ | Density |
|---|---|---|
| Composition | (g/10 min) | (g/cm³) |
| LDPE-1 | 0.40 | 0.9245 |
| LDPE-2 | 2.15 | 0.9195 |
| DOWLEX NG XUS 61530.02 | 0.8 | 0.917 |
| (“LLDPE-1”) | | |
| LDPE132I | 0.25 | 0.921 |
| DOWLEX 2045G LLDPE | 1.0 | 0.920 |
| ELITE 5400G | 1.0 | 0.916 |
| ELITE 5111G | 0.85 | 0.9255 |

DOWLEX NG XUS 61530.02 (“LLDPE-1”), LDPE 132I, DOWLEX 2045G LLDPE, ELITE 5111G and ELITE 5400G are commercially available from The Dow Chemical Company (Midland, MI, USA). Table 21 summarizes the optical and mechanical properties of Inventive Film Examples 9-12 and Comparative Film Example 2.

TABLE 21

| | Inv. Film | Comp. Film | Inv. Film | Inv. Film | Inv. Film |
|---|---|---|---|---|---|
| | Ex. 9 | Ex. 2 | Ex. 10 | Ex. 11 | Ex. 12 |
| MD Ult. Tensile Strength | 37.1 MPa | 33.8 MPa | 33.7 MPa | 32.9 MPa | 34.7 MPa |
| Ult. Elongation (MD), % | 939 | 983 | 943 | 996 | 952 |
| Tensile Energy (MD), J | 25.1 | 24.9 | 24.4 | 24.4 | 23.8 |
| TD Ult. Tensile Strength | 37.8 MPa | 34.5 MPa | 34.1 MPa | 34.3 MPa | 34.5 MPa |
| Ult. Elongation (TD), % | 995 | 1106 | 1071 | 1108 | 996 |
| Tensile Energy (TD), J | 24.8 | 25.4 | 24.0 | 25.2 | 21.7 |
| Young Modulus (MD) | 311.1 MPa | 239.8 MPa | 250 MPa | 259.1 MPa | 235.3 MPa |
| Secant Modulus @1% | 350 | 303.4 | 301.9 | 321.5 | 297.2 |
| (MD), MPa | | | | | |
| Secant Modulus @2% | 286.4 | 241.3 | 243.7 | 257.7 | 237.4 |
| (MD), MPa | | | | | |
| Young Modulus (TD) | 334.4 MPa | 257.3 MPa | 277.8 MPa | 280.9 MPa | 251.6 MPa |
| Secant Modulus @1% | 395.2 | 323.6 | 332.7 | 350.1 | 324.5 |
| (TD), MPa | | | | | |
| Secant Modulus @2% | 314.4 | 255.7 | 265.9 | 277.4 | 254.4 |
| (TD), MPa | | | | | |

Elmendorf Tear - ASTM D1922

| | | | | | |
|---|---|---|---|---|---|
| MD@6400 gm, N | 5.14 | 6.52 | 4.14 | 4.40 | 5.36 |
| TD@6400 gm, N | 13.4 | 16.32 | 9.82 | 10.89 | 10.61 |

Optics

| | | | | | |
|---|---|---|---|---|---|
| Haze, ASTM D1003-01 | 12.9% | 18.2% | 12.3% | 14.3% | 14.3% |
| Gloss at 45°, ASTM | 81.0 | 44.7 | 66.9 | 71 | 68.1 |
| D2457-97 | | | | | |

Shrinkage

| | | | | | |
|---|---|---|---|---|---|
| MD@130° C., % | 72.0 | 71.7 | 75.0 | 70.0 | 71.7 |
| TD@130° C., % | 26.0 | 30.0 | 41.7 | 31.7 | 31.7 |

Dart Impact - ASTM D1709

| | | | | |
|---|---|---|---|---|
| Type A, g | 283.5 | 283.5 | 259.5 | 475.5 |

| | | | |
|---|---|---|---|
| Type B, g | 154.0 | Film break at min. dart weight (140 g) | 180.5 |

Puncture*

| | | | | | |
|---|---|---|---|---|---|
| Peak Load, N | 90.7 | 71.3 | 73.1 | 71.0 | 75.9 |
| Elongation at | 60.7 mm | 44.32 mm | 46.65 mm | 46.38 mm | 46.49 mm |
| Peak Load | | | | | |
| Puncture Resistance, mm | 76.6 | 61.98 | 63.17 | 63.68 | 62.9 |
| Total Energy, J | 4.77 | 3.05 | 3.16 | 3.15 | 3.27 |

*The Puncture data in Table 21 were obtained in accordance with ASTM D 5748 except that the probe diameter used was 0.5 inches rather than 0.75 inches.

Composition test methods include the following: Density: Samples that are measured for density are prepared according to ASTM D-1928. Measurements are made within one hour of sample pressing using ASTM D- 792, Method B. Melt Index: Melt index, or I₂, is measured in accordance with ASTM-D 1238, Condition 190 ° C./2.16 kg, and is reported in grams eluted per 10 minutes. I₁₀ is measured in accordance with ASTM-D 1238, Condition 190 ° C./10 kg, and is reported in grams eluted per 10 minutes. Gel Permeation Chromatography (GPC): Samples were analyzed with a high-temperature GPC instrument (model PL220, Polymer Laboratories, Inc., now Agilent). Conventional GPC measurements were used to determine the weight-average molecular weight (Mw) and number-average molecular weight (Mn) of the polymer and to determine the molecular weight distribution, MWD or Mw/Mn. The z-average molecular weight, Mz, was also determined The method employed the well-known universal calibration method based on the concept of hydrodynamic volume, and the calibration was performed using narrow polystyrene (PS) standards along with three 10 μm Mixed-B columns (Polymer Laboratories Inc, now Agilent) operating at a system temperature of 140° C. Polyethylene samples were prepared at a 2 mg/mL concentration in 1,2,4-trichlorobenzene solvent by slowly stirring the sample in TCB at 160 ° C. for 4 hours. The flow rate was 10 mL/min, and the injection size was 200 microliters. The chromatographic solvent and the sample preparation solvent contained 200 ppm of butylated hydroxytoluene (BHT). Both solvent sources were nitrogen sparged. The molecular weights of the polystyrene standards were converted to polyethylene equivalent molecular weights using a correction factor of 0.4316 as discussed in the literature (T. Williams and I. M. Ward, Polym. Letters, 6, 621-624 (1968). A third order polynomial was used to fit the respective polyethylene-equivalent molecular weights of standards to the observed elution volumes. Crystallization Elution Fractionation (CEF) Method: Comonomer distribution analysis is performed with Crystallization Elution Fractionation (CEF) (PolymerChar in Spain) (B Monrabal et al, Macromol. Symp. 257, 71-79 (2007)). Ortho-dichlorobenzene (ODCB) with 600ppm antioxidant butylated hydroxytoluene (BHT) is used as solvent. Sample preparation is done with autosampler at 160° C. for 2 hours under shaking at 4 mg/ml (unless otherwise specified). The injection volume is 300 μl. The temperature profile of CEF is: crystallization at 3° C./min from 110° C. to 30° C., the thermal equilibrium at 30° C. for 5 minutes, elution at 3° C./min from 30° C. to 140° C. The flow rate during crystallization is at 0.052 ml/min. The flow rate during elution is at 0.50 ml/min. The data is collected at one data point/second. CEF column is packed by the Dow Chemical Company with glass beads at 125 μm±6% (MO-SCI Specialty Products) with ⅛ inch stainless tubing. Glass beads are acid washed by MO-SCI Specialty with the request from the Dow Chemical Company. Column volume is 2.06 ml. Column temperature calibration is performed by using a mixture of NIST Standard Reference Material Linear polyethylene 1475a (1.0mg/ml) and Eicosane (2mg/ml) in ODCB. Temperature is calibrated by adjusting elution heating rate so that NIST linear polyethylene 1475a has a peak temperature at 101.0° C., and Eicosane has a peak temperature of 30.0° C. The CEF column resolution is calculated with a mixture of NIST linear polyethylene 1475a (1.0mg/ml) and hexacontane (Fluka, purum, ≧97.0%, 1 mg/ml). A baseline separation of hexacontane and NIST polyethylene 1475a is achieved. The area of hexacontane (from 35.0 to 67.0° C.) to the area of NIST 1475a from 67.0 to 110.0° C. is 50 to 50, the amount of soluble fraction below 35.0° C. is <1.8 wt %. The CEF column resolution is defined in the following equation:

$$Resolution = \frac{\begin{matrix}Peak temperature of NIST 1475 a - \\ Peak Temperature of Hexacontane\end{matrix}}{\begin{matrix}Half \text{-} height Width of NIST 1475 a + \\ Half \text{-} height Width of Hexacontane\end{matrix}}$$

where the column resolution is 6.0.

Comonomer Distribution Constant (CDC) Method: Comonomer distribution constant (CDC) is calculated from comonomer distribution profile by CEF. CDC is defined as Comonomer Distribution Index divided by Comonomer Distribution Shape Factor multiplying by 100 as shown in the following equation:

$$\begin{matrix}CDC = \frac{Comonomer Distrubution Index}{Comonomer Distribution Shape Factor} \\ = \frac{Comonomer Distribution Index}{Half Width / Stdev} * 100\end{matrix}$$

Comonomer distribution index stands for the total weight fraction of polymer chains with the comonomer content ranging from 0.5 of median comonomer content (C_{median}) and 1.5 of C_{median} from 35.0 to 119.0° C. Comonomer Distribution Shape Factor is defined as a ratio of the half width of comonomer distribution profile divided by the standard deviation of comonomer distribution profile from the peak temperature (Tₚ).

CDC is calculated from comonomer distribution profile by CEF, and CDC is defined

$${\int }_{35}^{119.0} {w}_{T} ( T ) d T = 1$$

as Comonomer Distribution Index divided by Comonomer Distribution Shape Factor multiplying by 100 as shown in the following Equation:

$${\int }_{35}^{{T}_{median}} {w}_{T} ( T ) d T = 0.5$$

$$\begin{matrix}CDC = \frac{Comonomer Distrubution Index}{Comonomer Distribution Shape Factor} \\ = \frac{Comonomer Distribution Index}{Half Width / Stdev} * 100\end{matrix}$$

$$ln ( 1 - comonomerc ontent ) = - \frac{207.26}{273.12 + T} + 0.5533$$

$${R}^{2} = 0.997$$

wherein Comonomer distribution index stands for the total weight fraction of polymer chains with the comonomer content ranging from 0.5 of median comonomer content (C_{median}) and 1.5 of C_{median} from 35.0 to 119.0° C., and wherein Comonomer Distribution Shape Factor is defined as a ratio of the half width of comonomer distribution profile divided by the standard deviation of comonomer distribution profile from the peak temperature (Tp).

CDC is calculated according to the following steps:

(A) Obtain a weight fraction at each temperature (T) (w_{T}(T)) from 35.0° C. to 119.0° C. with a temperature step increase of 0.200° C. from CEF according to the following Equation:

(B) Calculate the median temperature (T_{median}) at cumulative weight fraction of 0.500, according to the following Equation:

(C) Calculate the corresponding median comonomer content in mole % (C_{median}) at the median temperature (T_{median}) by using comonomer content calibration curve according to the following Equation:

(D) Construct a comonomer content calibration curve by using a series of reference materials with known amount of comonomer content, i.e., eleven reference materials with narrow comonomer distribution (mono-modal comonomer distribution in CEF from 35.0 to 119.0° C.) with weight average M_{w} of 35,000 to 115,000 (measured via conventional GPC) at a comonomer content ranging from 0.0 mole % to 7.0 mole % are analyzed with CEF at the same experimental conditions specified in CEF experimental sections;

(E) Calculate comonomer content calibration by using the peak temperature (Tₚ) of each reference material and its comonomer content; The calibration is calculated from each reference material according to the following Equation:

$$Stdev = \sqrt{{\sum }_{35.0}^{119.0} {( T - {T}_{p} )}^{2} * {w}_{T} ( T )}$$

wherein: R² is the correlation constant;

(F) Calculate Comonomer Distribution Index from the total weight fraction with a comonomer content ranging from 0.5*C_{median} to 1.5*C_{median}, and if T_{median} is higher than 98.0° C., Comonomer Distribution Index is defined as 0.95;

(G) Obtain Maximum peak height from CEF comonomer distribution profile by searching each data point for the highest peak from 35.0° C. to 119.0° C. (if the two peaks are identical, then the lower temperature peak is selected); half width is defined as the temperature difference between the front temperature and the rear temperature at the half of the maximum peak height, the front temperature at the half of the maximum peak is searched forward from 35.0° C., while the rear temperature at the half of the maximum peak is searched backward from 119.0° C., in the case of a well defined bimodal distribution where the difference in the peak temperatures is equal to or greater than the 1.1 times of the sum of half width of each peak, the half width of the inventive ethylene-based polymer composition is calculated as the arithmetic average of the half width of each peak;

(H) Calculate the standard deviation of temperature (Stdev) according the following Equation:

$$ln ( 1 - comonomercontent ) = - \frac{207.26}{273.12 + T} + 0.5533$$

$${R}^{2} = 0.997$$

### Creep Zero Shear Viscosity Measurement Method

Zero-shear viscosities are obtained via creep tests that were conducted on an AR-G2 stress controlled rheometer (TA Instruments; New Castle, Del.) using 25-mm-diameter parallel plates at 190° C. The rheometer oven is set to test temperature for at least 30 minutes prior to zeroing fixtures. At the testing temperature a compression molded sample disk is inserted between the plates and allowed to come to equilibrium for 5 minutes. The upper plate is then lowered down to 50 μm above the desired testing gap (1.5 mm) Any superfluous material is trimmed off and the upper plate is lowered to the desired gap. Measurements are done under nitrogen purging at a flow rate of 5 L/min. Default creep time is set for 2 hours. A constant low shear stress of 20 Pa is applied for all of the samples to ensure that the steady state shear rate is low enough to be in the Newtonian region. The resulting steady state shear rates are in the range of 10⁻³ to 10⁻⁴ s⁻¹ for the samples in this study. Steady state is determined by taking a linear regression for all the data in the last 10% time window of the plot of log (J(t)) vs. log(t), where J(t) is creep compliance and t is creep time. If the slope of the linear regression is greater than 0.97, steady state is considered to be reached, then the creep test is stopped. In all cases in this study the slope meets the criterion within 2 hours. The steady state shear rate is determined from the slope of the linear regression of all of the data points in the last 10% time window of the plot of ε vs. t, where ε is strain. The zero-shear viscosity is determined from the ratio of the applied stress to the steady state shear rate. In order to determine if the sample is degraded during the creep test, a small amplitude oscillatory shear test is conducted before and after the creep test on the same specimen from 0.1 to 100 rad/s. The complex viscosity values of the two tests are compared. If the difference of the viscosity values at 0.1 rad/s is greater than 5%, the sample is considered to have degraded during the creep test, and the result is discarded.

Zero-Shear Viscosity Ratio (ZSVR) is defined as the ratio of the zero-shear viscosity (ZSV) of the branched polyethylene material to the ZSV of the linear polyethylene material at the equivalent weight average molecular weight (Mw-gpc) according to the following Equation:

$$ZSVR = \frac{{η}_{0 B}}{{η}_{0 L}} = \frac{{η}_{0 B}}{2.29 \times {10}^{- 15} {M}_{w \text{-} gpc}^{3.65}}$$

The ZSV value is obtained from creep test at 190° C. via the method described above. The Mw-gpc value is determined by the conventional GPC method. The correlation between ZSV of linear polyethylene and its Mw-gpc was established based on a series of linear polyethylene reference materials. A description for the ZSV-Mw relationship can be found in the ANTEC proceeding: Karjala, Teresa P.; Sammler, Robert L.; Mangnus, Marc A.; Hazlitt, Lonnie G.; Johnson, Mark S.; Hagen, Charles M., Jr.; Huang, Joe W. L.; Reichek, Kenneth N. Detection of low levels of long-chain branching in polyolefins. Annual Technical Conference—Society of Plastics Engineers (2008), 66th 887-891.

¹ H NMR Method: 3.26 g of stock solution is added to 0.133 g of polyolefin sample in 10 mm NMR tube. The stock solution is a mixture of tetrachloroethane-d₂ (TCE) and perchloroethylene (50:50, w:w) with 0.001M Cr³⁺. The solution in the tube is purged with N₂ for 5 minutes to reduce the amount of oxygen. The capped sample tube is left at room temperature overnight to swell the polymer sample. The sample is dissolved at 110° C. with shaking. The samples are free of the additives that may contribute to unsaturation, e.g. slip agents such as erucamide. The ¹H NMR are run with a 10 mm cryoprobe at 120° C. on Bruker AVANCE 400 MHz spectrometer. Two experiments are run to get the unsaturation: the control and the double pre-saturation experiments. For the control experiment, the data is processed with exponential window function with LB=1 Hz, baseline was corrected from 7 to −2 ppm. The signal from residual ¹H of TCE is set to 100, the integral Iₜₒₜₐₗ from −0.5 to 3 ppm is used as the signal from whole polymer in the control experiment. The number of CH₂ group, NCH₂, in the polymer is calculated as following: NCH₂=Iₜₒₜₐₗ/2. For the double presaturation experiment, the data is processed with exponential window function with LB=1 Hz, baseline was corrected from 6.6 to 4.5 ppm. The signal from residual ₁H of TCE is set to 100, the corresponding integrals for unsaturations (I_{viylene}, I_{trisubstituted}, I_{vinyl} and I_{vinylidene}) were integrated based on the region shown in the graph below

The number of unsaturation unit for vinylene, trisubstituted, vinyl and vinylidene are calculated:

N_{vinylene}=I_{vinylene}/2; N_{trisubstituted}=I_{trisubstitute}; N_{vinyl}=I_{vinyl}/2; N_{vinylidene}=I_{vinylidene}/2; The unsaturation unit/1,000,000 carbons is calculated as following: N_{vinylene}/1,000,000 C.=(N_{vinylene}/NCH₂)*1,000,000; N_{trisubstituted}/1,000,000 C.=(N_{trisubstituted/NCH}₂)*1,000,000; N_{vinyl}/1,000,000 C.=(N_{vinyl}/NCH₂)*1,000,000; N_{vinylidene}/1,000,000 C.=(N_{vinylidene}/NCH₂)*1,000,000. The requirement for unsaturation NMR analysis includes: level of quantitation is 0.47±0.02/1,000,000 carbons for Vd2 with 200 scans (less than 1 hour data acquisition including time to run the control experiment) with 3.9 wt % of sample (for Vd2 structure, see Macromolecules, vol. 38, 6988, 2005), 10 mm high temperature cryoprobe. The level of quantitation is defined as signal to noise ratio of 10. The chemical shift reference is set at 6.0 ppm for the ¹H signal from residual proton from TCT-d2. The control is run with ZG pulse, TD 32768, NS 4, DS 12, SWH 10,000 Hz, AQ 1.64s, D1 14s. The double presaturation experiment is run with a modified pulse sequence, 01P 1.354 ppm, 02P 0.960 ppm, PL9 57db, PL21 70 db, TD 32768, NS 200, DS 4, SWH 10,000 Hz, AQ 1.64s, D1 1 s, D13 13s. The modified pulse sequences for unsaturation with Bruker AVANCE 400 MHz spectrometer are shown below:

;lc1prf2_zz
prosol relations=<lcnmr>
#include <Avance.incl>
“d12=20u”
“d11=4u”
1 ze
d12 pl21:f2
2 30m
d13
d12 pl9:f1
d1 cw:f1 ph29 cw:f2 ph29
d11 do:f1 do:f2
d12 pl1:f1
p1 ph1
go=2 ph31
30m mc #0 to 2 F0(zd)
exit
ph1=0 2 2 0 1 3 3 1
ph29=0
ph31=0 2 2 0 1 3 3 1

DSC Crystallinity: Differential Scanning calorimetry (DSC) can be used to measure the melting and crystallization behavior of a polymer over a wide range of temperature. For example, the TA Instruments Q1000 DSC, equipped with an RCS (refrigerated cooling system) and an autosampler is used to perform this analysis. During testing, a nitrogen purge gas flow of 50 L/min is used. Each sample is melt pressed into a thin film at about 175° C.; the melted sample is then air-cooled to room temperature (−25 ° C.). A 3-10 mg, 6 mm diameter specimen is extracted from the cooled polymer, weighed, placed in a light aluminum pan (ca 50 mg), and crimped shut. Analysis is then performed to determine its thermal properties. The thermal behavior of the sample is determined by ramping the sample temperature up and down to create a heat flow versus temperature profile. First, the sample is rapidly heated to 180° C. and held isothermal for 3 minutes in order to remove its thermal history. Next, the sample is cooled to −40° C. at a 10° C./minute cooling rate and held isothermal at −40° C. for 3 minutes. The sample is then heated to 150° C. (this is the “second heat” ramp) at a 10° C./minute heating rate. The cooling and second heating curves are recorded. The cool curve is analyzed by setting baseline endpoints from the beginning of crystallization to −20° C. The heat curve is analyzed by setting baseline endpoints from −20° C. to the end of melt. The values determined are peak melting temperature (Tₘ), peak crystallization temperature (T_{c}), heat of fusion (H_{f}) (in Joules per gram), and the calculated % Crystallinity for polyethylene samples using the following Equation:

% Crystallinity=((H_{f})/(292 J/g))×100.

The heat of fusion (H_{f}) and the peak melting temperature are reported from the second heat curve. Peak crystallization temperature is determined from the cooling curve.

Dynamic Mechanical Spectroscopy (DMS) Frequency Sweep: Resins were compression-molded into 3 mm thick×1 inch circular plaques at 350° F. for 5 minutes under 1500 psi pressure in air. The sample is then taken out of the press and placed on the counter to cool. A constant temperature frequency sweep is performed using a TA Instruments “Advanced Rheometric Expansion System (ARES),” equipped with 25 mm parallel plates, under a nitrogen purge. The sample is placed on the plate and allowed to melt for five minutes at 190° C. The plates are then closed to 2 mm, the sample trimmed, and then the test is started. The method has an additional five minute delay built in, to allow for temperature equilibrium. The experiments are performed at 190° C. over a frequency range of 0.1 to 100 rad/s. The strain amplitude is constant at 10%. The stress response is analyzed in terms of amplitude and phase, from which the storage modulus (G′), loss modulus (G″), complex modulus (G*), dynamic viscosity η*, and tan (δ) or tan delta are calculated.

Melt strength: Melt strength is measured at 190 ° C. using a Goettfert Rheotens 71.97 (Goettfert Inc.; Rock Hill, S.C.), melt fed with a Goettfert Rheotester 2000 capillary rheometer equipped with a flat entrance angle (180 degrees) of length of 30 mm and diameter of 2 mm. The pellets are fed into the barrel (L=300 mm, Diameter=12 mm), compressed and allowed to melt for 10 minutes before being extruded at a constant piston speed of 0.265 mm/s, which corresponds to a wall shear rate of 38.2s⁻¹ at the given die diameter. The extrudate passes through the wheels of the Rheotens located at 100 mm below the die exit and is pulled by the wheels downward at an acceleration rate of 2.4 mm/s² The force (in cN) exerted on the wheels is recorded as a function of the velocity of the wheels (in mm/s) Melt strength is reported as the plateau force (cN) before the strand broke.

Film test methods included the following: Total (Overall) Haze and Internal Haze^{.} Internal haze and total haze were measured according to ASTM D 1003-07. Internal haze was obtained via refractive index matching using mineral oil (1-2 teaspoons), which was applied as a coating on each surface of the film. A Hazegard Plus (BYK-Gardner USA; Columbia, Md.) is used for testing. For each test, five samples were examined, and an average reported. Sample dimensions were “6 in×6 in.” 45° Gloss: ASTM D2457-08 (average of five film samples; each sample “10 in×10 in”). Clarity: ASTM D1746-09 (average of five film samples; each sample “10 in×10 in”). 1% and 2% Secant Modulus-MD (machine direction) and CD (cross direction): ASTM D882-10 (average of five film samples in each direction; each sample “1 in×6 in”). CD and MD Ultimate Tensile, CD and MD Tensile Peak Load, CD and MD Ultimate Elongation, CD and MD Tensile Yield Strain, CD and MD Tensile Yield Strength: (average of five film samples in each direction; each sample “1 in×6 in”). CD and MD Tensile Thickness: ASTM D882-10. MD and CD Elmendorf Tear Strength: ASTM D1922-09 (average of 15 film samples in each direction; each sample “3 in×2.5 in” half moon shape). Dart Impact Strength: ASTM D1709-09 (minimum of 20 drops to achieve a 50% failure; typically ten “10 in x 36 in” strips). Puncture Strength: Puncture (except for the data in Table 21) was measured on an INSTRON Model 4201 with SINTECH TESTWORKS SOFTWARE Version 3.10. The specimen size was “6 in×6 in,” and four measurements were made to determine an average puncture value. The film was conditioned for 40 hours after film production, and at least 24 hours in an ASTM controlled laboratory (23° C. and 50% relative humidity). A “100 lb” load cell was used with a round specimen holder of 4 inch diameter. The puncture probe is a “½ inch diameter” polished stainless steel ball (on a 2.5″ rod) with a “7.5 inch maximum travel length.” There was no gauge length, and the probe was as close as possible to, but not touching, the specimen (the probe was set by raising the probe until it touched the specimen). Then the probe was gradually lowered, until it was not touching the specimen. Then the crosshead was set at zero. Considering the maximum travel distance, the distance would be approximately 0.10 inch. The crosshead speed was 10 inches/minute. The thickness was measured in the middle of the specimen. The thickness of the film, the distance the crosshead traveled, and the peak load were used to determine the puncture by the software. The puncture probe was cleaned using a “KIM-WIPE” after each specimen. Shrink Tension: Shrink tension was measured according to the method described in Y. Jin, T. Hermel-Davidock, T. Karjala, M. Demirors, J. Wang, E. Leyva, and D. Allen, “Shrink Force Measurement of Low Shrink Force Films”, SPE ANTEC Proceedings, p. 1264 (2008). The shrink tension of film samples was measured through a temperature ramp test that was conducted on an RSA-III Dynamic Mechanical Analyzer (TA Instruments; New Castle, Del.) with a film fixture. Film specimens of “12.7 mm wide” and “63.5 mm long” were die cut from the film sample, either in the machine direction (MD) or the cross direction (CD), for testing. The film thickness was measured by a Mitutoyo Absolute digimatic indicator (Model C112CEXB). This indicator had a maximum measurement range of 12.7 mm, with a resolution of 0.001 mm. The average of three thickness measurements, at different locations on each film specimen, and the width of the specimen, were used to calculate the film's cross sectional area (A), in which “A=Width×Thickness” of the film specimen was used in shrink film testing. A standard film tension fixture from TA Instruments was used for the measurement. The oven of the RSA-III was equilibrated at 25° C. for at least 30 minutes, prior to zeroing the gap and the axial force. The initial gap was set to 20 mm. The film specimen was then attached onto both the upper and the lower fixtures. Typically, measurements for MD only require one ply film. Because the shrink tension in the CD direction is typically low, two or four plies of films are stacked together for each measurement to improve the signal-to-noise ratio. In such a case, the film thickness is the sum of all of the plies. In this work, a single ply was used in the MD direction and two plies were used in the CD direction. After the film reached the initial temperature of 25° C., the upper fixture was manually raised or lowered slightly to obtain an axial force of −1.0 g. This was to ensure that no buckling or excessive stretching of the film occurred at the beginning of the test. Then the test was started. A constant fixture gap was maintained during the entire measurement. The temperature ramp started at a rate of 90° C./min, from 25° C. to 80° C., followed by a rate of 20° C./min from 80° C. to 160° C. During the ramp from 80° C. to 160° C., as the film shrunk, the shrink force, measured by the force transducer, was recorded as a function of temperature for further analysis. The difference between the “peak force” and the “baseline value before the onset of the shrink force peak” is considered the shrink force (F) of the film. The shrink tension of the film is the ratio of the shrink force (F) to the cross sectional area (A) of the film. Free shrink: A 4×4″ specimen of the sample was placed in a film holder then immersed in a hot oil bath for 30 seconds at the desired temperature. The oil used is Dow Corning 210H. After 30 seconds, the film holder/sample is removed, allowed to cool, and then the specimen is measured in both machine and cross directions. The % shrinkage is then calculated from the measurement of the initial length of the sample, Lo, vs. the newly measured length after being in the hot oil bath per the above procedure, Lf. % Shrinkage=[(Lf-Lo)/Lo]*100

Unless otherwise stated, implicit from the context or conventional in the art, all parts and percentages are based on weight. All applications, publications, patents, test procedures, and other documents cited, including priority documents, are fully incorporated by reference to the extent such disclosure is not inconsistent with the disclosed compositions and methods and for all jurisdictions in which such incorporation is permitted.

The present invention may be embodied in other forms without departing from the spirit and the essential attributes thereof, and, accordingly, reference should be made to the appended claims, rather than to the foregoing specification, as indicating the scope of the invention.

1. A multi-layered shrink film comprising:
at least three layers including two skin layers and at least one core layer; wherein at least one layer comprises from 10 to 100 weight percent units derived from one or more ethylene-based polymer compositions characterized by having CDC in the range of from 90 to 130, a vinyl unsaturation of from 55 to 70 vinyls/1,000,000 C; a ZSVR in the range from at least 8 to 12; a density in the range of 0.93 to 0.94 g/cm³, a melt index (I₂) in the range of from 0.3 to 0.6 g/10 minutes, a molecular weight distribution (Mw/Mn) in the range of from 2 to 4, and a molecular weight distribution (Mz/Mw) in the range of from 1.5 to 3; and wherein the multi-layered film exhibits at least one characteristic selected from the group consisting of 45 degree gloss of at least 50%, a total haze of 15% or less, an internal haze of 8% or less, 1% CD Secant Modulus of 43,000 psi or greater, 1% MD Secant Modulus of 38,000 psi or greater, CD shrink tension of at least 0.7 psi, and/or MD shrink tension of at least 10 psi.

2. The multi-layered shrink film according to claim 1, wherein each layer further comprises one or more polymers selected from the group consisting of polypropylene, polyethylene, ethylene/propylene copolymer, ethylene-vinyl acetate (EVA), ethylene/vinyl alcohol copolymer, olefin plastomer and elastomer in quantities such that each layer comprises a total of from 92.5 to 100 weight percent total polymer.

3. The multi-layered shrink film according to claim 1, wherein the shrink film comprises a total of 3 layers including two skin layers and one core layer; and wherein the core layer comprises 30 to 60 weight percent ethylene-based polymer composition.

4. The multi-layered shrink film according to claim 3, wherein the core layer comprises 40 wt % of the ethylene-based polymer composition and 60 wt % polyethylen;
the polyethylene having a density from 0.918 to 0.960 g/cm³and an I₂ from 0.2 to 2.

5. The multi-layered shrink film according to claim 1, wherein the shrink film comprises a total of 3 layers including two skin layers and one core layer; wherein at least one skin layer comprises 30 to 60 weight percent of the ethylene-based polymer composition.

6. The multi-layered shrink film according to claim 1, wherein the film is produced using a co-extrusion process.

7. The multi-layered shrink film according to claim 1, wherein the ethylene-based polymer composition is characterized by having a molecular weight distribution (Mw/Mn) in the range of from 2.0 to 3.3, and a molecular weight distribution (Mz/Mw) in the range of from 1.5 to 2.5.

8. (canceled)

9. The multi-layered shrink film according to claim 1, wherein a ratio of a thickness of one of the skin layers to a thickness of the core layer is from 1:20 to 1:2.

10. The multi-layered shrink film according to claim 1, wherein a ratio of a thickness of one of the skin layers to a thickness of the core layer is from 1:10 to 1:3.

11. The multi-layered shrink film according to claim 1, wherein both skin layers comprise LLDPE, other than the ethylene-based polymer composition, the LLPPE having a density from 0.912 to 0.925 g/cm³ and an I₂ from 0.2 to 2 g/10 min.

12. The multi-layered shrink film according to claim 1, wherein both skin layers comprise LLDPE, other than the ethylene-based polymer composition, the LLPPE having a density from 0.915 to 0.922 g/cm³ and an I₂ from 0.5 to 1.5 g/10 min.

13. (canceled)

14. The multi-layered shrink film according to claim 1, wherein the ethylene-based polymer composition density ranges from 0.930 to 0.940 g/cm³.
